(19) United States
(12) Patent Application Publication
(10) Pub. No.: US 2009/0106062 A1
(43) Pub. Date: Apr. 23, 2009

(54) Employee performance return on investment

(76) Inventor: Michael J. O'Neill, Delafield, WI (US)

Correspondence Address: BRINKS HOFER GILSON & LIONE, P.O. BOX 10395, CHICAGO, IL, 60610, US

(21) Appl. No.: 11/975,802

(22) Filed: Oct. 22, 2007

(51) Int. Cl. G06Q 10/00

(52) U.S. Cl. 705/7

(57) ABSTRACT

An Employee Performance Return on Investment (EP-ROI) tool helps a customer decide where to make investments in workplace design features to optimize employee performance and, thus, maximize the impacts on the financial productivity of the organization. The EP-ROI tool considers many factors in illustrating the impact on predicted business outcome values given various levels of investment in workplace design features. For example, the EP-ROI tool considers the customer's workplace environment type, such as a call center or professional\office, and the customer's remodeling or construction project type when developing the predicted business outcome values. In addition, the EP-ROI tool considers a customer's employee job types and their associated work process characteristics in reaching the predicted business outcome values. Furthermore, the EP-ROI tool allows a customer to create multiple customer models in illustrating the effects investing in different workplace design features have on predicted business outcome values. For example, the customer may refer to previously created models in reaching an informed business decision for investing in workplace design features. Hence, a customer may use the EP-ROI tool to create successive approximations that ultimately permit the customer to optimize the outcomes of the model to support their specific business objectives.

### BACKGROUND

1. Technical Field

This application relates to linking workspace design features to changes in employee behavior, and subsequent financial and performance outcomes in various industries.

2. Related Art

In most corporate real estate and facilities business applications, a typical return on investment (ROI) tool allows a user to estimate a return on investment in terms of estimated savings resulting from investing in a capital improvement. In the world of office workplace design, existing furniture ROI tools allow the user to compute savings related to the management of the furniture, such as cabling, churning costs, installation times, and other costs that result from implementing a particular office furniture system.

However, existing furniture ROI tools often focus on specific workspace products to determine the employee performance return on investment from purchasing or using those products. Hence, a user of an existing ROI tool is limited to the specific furniture models used by the ROI tool to determine the savings in various financial and performance outcomes.

Furthermore, existing ROI tools determine the cost savings related to the installation and management of furniture products due to the technical design features of those products. Thus, these ROI tools do not determine the effects of workspace design features on employee performance and organizational productivity. Rather, the focus of these ROI tools is on cost savings related to their use. In general, their use as a management decision-making tool is limited to understanding the cost impacts of furniture design, and not in determining the effects of workspace design features on productivity and performance.

### BRIEF DESCRIPTION OF THE DRAWINGS

The innovation may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 shows an example of a system that determines predicted business outcome values using workplace design features.

FIG. 2 shows various modules implemented by the executable instruction sets of FIG. 1 used to determine predicted business outcome values.

FIG. 3 shows an exemplary interface for interacting with a workplace environment type selection module.

FIG. 4 shows an exemplary interface for interacting with a business data module.

FIG. 5 shows an exemplary interface for interacting with a workplace design feature investment amount module.

FIG. 6 shows the exemplary interface of FIG. 5 when the workplace design feature investment amounts are adjusted.

FIG. 7 shows an exemplary interface for interacting with a workplace component cost module and a predicted business outcome module.

FIG. 8 shows an exemplary interface for interacting with an optimization module.

FIG. 9 shows the exemplary interface of FIG. 8 when a possible retention rate predicted business outcome value is optimized.

FIG. 10 shows an additional exemplary interface for interacting with the business data module.

FIG. 11 shows an exemplary interface for providing business specific data and current performance estimates for a manager type employee.

FIG. 12 shows an exemplary interface for providing business specific data and current performance estimates for a professional type employee.

FIG. 13 shows an exemplary interface for providing business specific data and current performance estimates for a technical type employee.

FIG. 14 shows an exemplary interface for providing business specific data and current performance estimates for an office operations type employee.

FIG. 15 shows an exemplary interface for selecting a project type when a professional\office workplace environment type is selected.

FIG. 16 an exemplary interface for interacting with the workplace design feature investment amount module and the predicted business outcome module.

FIG. 17 shows the exemplary interface of FIG. 16 when the workplace design feature investment amounts are adjusted.

FIG. 18 shows an additional exemplary interface for interacting with the optimization module.

FIG. 19 shows the exemplary interface of FIG. 18 when a possible process time predicted business outcome value is optimized.

FIGS. 20-23 show flow diagrams for determining predicted business outcome values using workplace design feature investment amounts.

### DETAILED DESCRIPTION

The disclosed employee performance return on investment (EP-ROI) tool overcomes the problems of current ROI tools by linking physical workstation and workspace design features to changes in employee behavior and related financial and performance outcomes. The EP-ROI tool achieves this technical measure by calculating the relationships between workplace design features and performance outcomes using data and empirical relationships, such as those derived from research in this field. The EP-ROI tool is also customizable and uses various project models to help customers determine their return on investing in different capital improvements. In general, a model is a collection of rules and variables where the values of the variables may be varied to observe different outcomes from the rules.

The EP-ROI tool is configured to associate a variety of values, inputs, and outputs as a customer model associated with a customer model identifier. Thus, a customer may use the EP-ROI tool to prepare a customer model and save the values used in creating the customer model for later retrieval. When the customer then retrieves the saved customer model using the customer model identifier, a customer may then edit the values used in creating the model, and may then re-save the customer model under a different customer model identifier. Hence, the EP-ROI tool allows a single customer to have a variety of models to aid in determining the amount of investment that yields optimized employee performance and financial outcomes.

The EP-ROI tool includes a processor, a storage device, an input device, and an output device. The storage device is operative to store executable instruction sets that implement several different modules. These modules include a workplace environment type selection module, a business data module, a project type selection module, a workplace design feature investment amount module, and a predicted business outcome module 214. The processor is operative to execute the executable instruction sets stored by the storage device.

The modules are configured to perform a variety of operations. The workplace environment type selection module receives a workplace environment type and passes the selected workplace environment type onto the business data module and the predicted business outcome module 214. The business data module uses the workplace environment type to operate on business specific data values and current estimate values corresponding to the workplace environment type. The project type selection module receives a selected project type that corresponds to the selected workplace environment type. The workplace design feature investment module operates on several different workplace design feature investment amounts that correspond to workplace design features. Finally, the predicted business outcome module 214 uses the business specific data values, the current performance estimates, the workplace design feature investment amounts, and the selected project type to calculate several predicted business outcome values. A reporting module may then prepare a report for outputting the business predicted outcome values to the output device.

Using the EP-ROI tool, a customer may thus determine the amount to invest in workplace design feature, rather than any specific workplace model or service, that yields an optimized return on employee performance and behavior.

The elements illustrated in the Figures interoperate as explained in more detail below. Before setting forth the detailed explanation, however, it is noted that all of the discussion below, regardless of the particular implementation being described, is exemplary in nature, rather than limiting. For example, although selected aspects, features, or components of the implementations are depicted as being stored in memories, all or part of systems and methods consistent with the innovations may be stored on, distributed across, or read from other machine-readable media, for example, secondary storage devices such as hard disks, floppy disks, and CD-ROMs; a signal received from a network; or other forms of ROM or RAM either currently known or later developed.

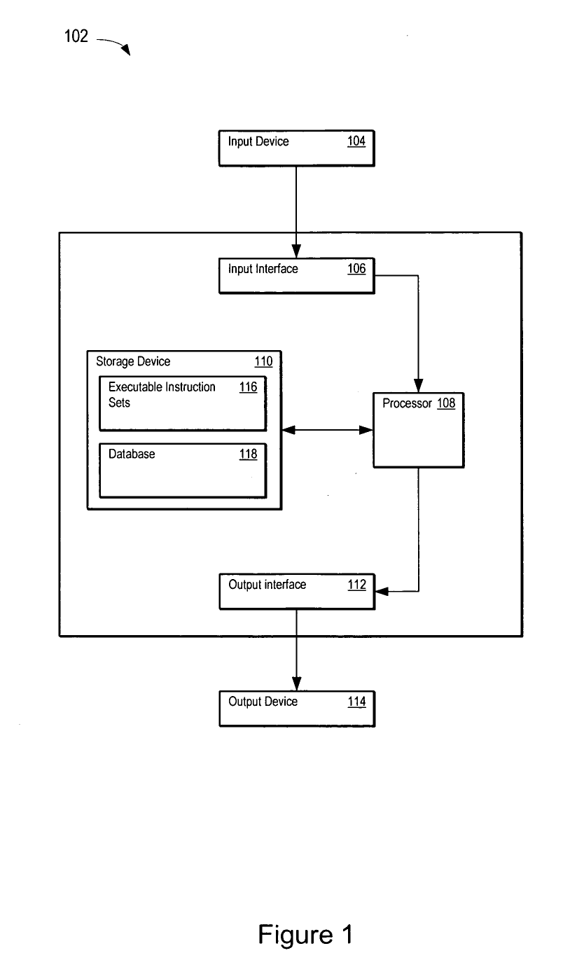

FIG. 1 shows an example of the EP-ROI tool 102 that determines predicted business outcome values using workplace design features. The EP-ROI tool 102 includes an input device 104, an input interface 106, a processor 108, a storage device 110, an output interface 112, and an output device 114. Each of the components 104-114 may be in communication with one another.

The input device 104 may be an audio input device, a tactile input device, a memory storage device, any now known or later developed input device, or combinations thereof. In one example, the input device 104 is a microphone. In another example, the input device 104 is a keyboard, mouse, trackball, touch pad or other pointer control. In another example, the input device 104 is a memory storage device, such as a hard disk drive, compact disc, digital video disc, flash memory, random access memory, or combinations thereof.

The input interface 106 is coupled with the input device 104 and operative to communicate with the processor 108. The input interface 106 may be a wired interface, such as PS/2, USB, Ethernet, IDE/ATA, SCSI, or SATA, IEEE 1394, a wireless interface, such as 802.11 a/b/g, Bluetooth, RF, infrared, an audio interface, such as stereo, S/PDIF, AES/EBU, or combinations thereof. In one embodiment, the input interface 106 is a PS/2 interface coupled with the input device 104, which is a keyboard. In another embodiment, the input interface 106 is an IDE/ATA interface and the input device 104 is a hard drive.

The processor 108 is a general processor, a data signal processor, graphics card, graphics chip, personal computer, motherboard, memories, buffers, scan converters, filters, interpolators, field programmable gate array, application-specific integrated circuit, analog circuits, digital circuits, combinations thereof, or any other now known or later developed processing or rendering device. The processor 108 may also be a software module written in a computer programming language, such as Visual Basic or C. The processor 108 communicates with the storage device 110 to execute the executable instruction sets and process input received from the input device 104. The processor 108 may further provide data to the output interface 112 to output on the output device 114.

The storage device 110 is operative to store executable instruction sets 116 and a database 118. The storage device 110 may be random access memory, cache memory, dynamic random access memory, static random access memory, flash memory, virtual memory, video memory, magnetic memory, optical memory, any known or later developed memory technology, or combinations thereof. In one embodiment, the storage device 110 is a hard drive. In another embodiment, the storage device 110 is a DVD+RW. In a further embodiment, the storage device 110 is a secure digital (SD) card, or other now known or later developed data storage device. The storage device 110 may be further operative to communicate with the processor 108, such that the processor 108 is operative to receive the executable instruction sets 116 and is further operative to access the database 118.

The output interface 112 facilitates the output of data, such as predicted business outcome values, to the output device 114. The output interface 112 may be a wired interface, such as PS/2, USB, Ethernet, IDE/ATA, SCSI, SATA, IEEE 1394, VGA, or DVI, a wireless interface, such as 802.11 a/b/g, Bluetooth, RF, infrared, an audio interface, such as stereo, S/PDIF, AES/EBU, or combinations thereof.

The output device 114 is in communication with the processor 108 and operative to output data processed by the processor 108, such as calculated predicted business outcome values. The output device 114 is a monitor, CRT, LCD, plasma screen, flat-panel, projector are other now known or later developed display device. The output device 114 may further display text and/or graphics representative of an interface for the user to interact with the EP-ROI tool 102.

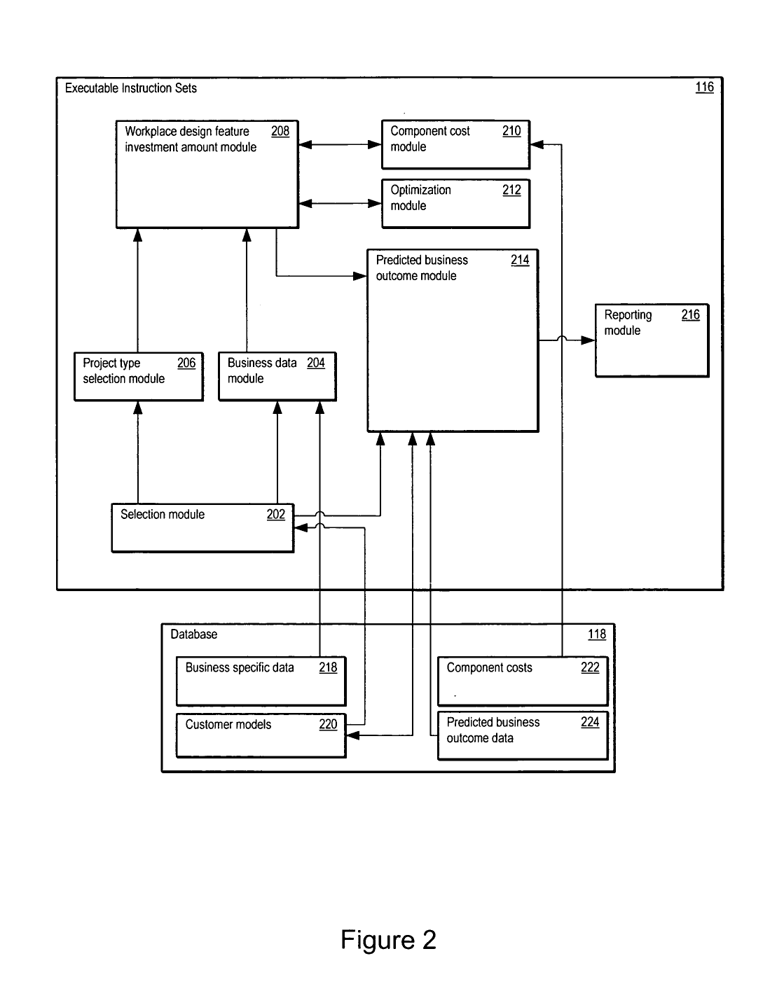

FIG. 2 shows various modules implemented by the executable instruction sets of FIG. 1 used by the EP-ROI tool 102 to determine predicted business outcome values. In general, the executable instruction sets 114 may implement a workplace environment type selection module 202, a business data module 204, a project type selection module 206, a workplace design feature investment amount module 208, a predicted business outcome module 214, and a reporting module 216. The executable instruction sets 116 may further implement a workplace component cost module 210 and a maximize/minimize module 212.

The modules 202-216 may be implemented in hardware, software, or combinations thereof. For example, the modules 202-216 may be implemented as one or more hardware processors. As another example, the modules 202-216 may be implemented in a computer programming language, such as a Visual Basic or C. A computer program may also implement the modules 202-216 and provide an interface for user interaction with the modules 202-216, such as the Microsoft® Excel® computer program available from the Microsoft Corporation located in Redmond, Wash. In yet a further embodiment, each of the modules 202-216 may be implemented for online accessibility, such as by being implemented in Javascript, on the .NET platform, or other computer programming language, and accessible via the Internet through an HTML interface.

FIG. 2 also shows that the storage device 110 is operative to store a database 118. In turn, the database 118 may include tables 218-224 that are in communication and accessible by the modules 202-216. Examples of tables stored by the database 118 includes a business specific data table 218, a customer model table 220, a component cost table 222, and a predicted business outcome data table 224. The EP-ROI tool 102 may implement the database 118 and its tables 218-224 as hardware, software, or combinations thereof. For example, the database 118 may be implemented as part of a Microsoft® SQL Server, also available from the Microsoft® Corporation. Alternatively the database 118 may be implemented as part of the Microsoft® Excel® computer program, with each table 218-224 implemented as part of a worksheet within the Microsoft® Excel® computer program.

In one implementation, the workplace environment type selection module 202 creates a customer model identifier for a customer and facilitates the association of data values with the created customer model identifier. The data values associated with the customer model identifier may include business specific data values, current performance estimate values, workplace design feature investment amounts, and one or more calculated predicted business outcome values. The data values associated with the created customer model identifier may form a customer model. The workplace environment type selection module 202 also receives a selection of a workplace environment type. Workplace environment types may include “Call Center,” “Professional\Office,” or other workplace environment types. The workplace environment type selection module 202 may transmit the selected workplace environment type to the business data module 204 and the predicted business outcome module 214.

Alternatively to creating a new customer model, the workplace environment selection module 202 may use a previously created customer model identifier to load a previously stored customer model from the customer models table 220. Loading the customer model may include retrieving the business specific data values, the current performance estimate values, the workplace design feature investment amounts, and one or more calculated predicted business outcome value using the associated first customer model identifier. By loading a previously stored customer model, one or more modules 202-214 may adjust the values associated with the previously stored customer model, or the workplace environment type selection module 202 may create a new customer model using the data values of the previously stored customer model.

The business data module 204 is in communication with the workplace environment type selection module 202 and is operative to receive the selected workplace environment type. The business data module 204 is also in communication with the business specific data table 218. The business specific data table 218 is operative to store business specific data values and current performance estimate values. Using the selected workplace environment type, the business data module 204 may then retrieve default business specific data values and current performance estimate values from the business specific data table 218.

Each workplace environment type of the EP-ROI tool 102 may have multiple corresponding business specific data values and multiple corresponding current performance estimate values. For example, for a “Call Center” workplace environment type, business specific data values may include a number of call center agents, the average calls per day for each agent, the cost of not resolving a call on first contact between an agent and a calling customer, the average hourly cost per average agent, and the cost to hire and train a new agent. Current performance estimate values for a “Call Center” workplace environment type may include a first call resolution percentage, an after-call work time (the average number of seconds a call center agent spends completing work related to a call from a customer, after that call is ended), a retention percentage of agents for a call center, and an estimated annual medical insurance claim amount per call center agent. Table 1 below shows one example of default values for the business specific data values and the current performance estimate values of a “Call Center” workplace environment type stored in the business specific data table 218.

TABLE 1

| Business Specific Data | | Current Performance Estimates | |
|---|---|---|---|
| Number of call | 500 | First Call | 67% |
| center agents | | Resolution (%) | |
| Average calls per | 50 | After Call Work | 441.00 |
| day per agent | | (Seconds) | |
| Cost per call not | $7.22 | Retention (%) | 77% |
| resolved on first | | | |
| contact | | | |
| Average hourly cost | $14.25 | Estimated | $1,074.00 |
| per average agent | | Annual Claim | |
| (salary and benefits) | | Amount per | |
| | | Agent | |
| Cost to hire and | 25% | | |
| train new agent (% | | | |
| salary and benefits) | | | |

In addition to the business specific data values and current performance estimate values for a call center workplace environment type, the business specific data table 218 may also store data values for a professional/office workplace environment type. In contrast to a call center workplace environment type, the data values for a professional/office workplace environment type may include business specific data values and current performance estimate values for different employee types. Examples of employee types include manager, professional, technical, and office operations.

In one implementation, a manager employee type corresponds to an employee that spends the majority of their time managing other employees. A professional employee type corresponds to an employee who spends the majority of their time engaged in producing work products related to a specific field or content area. A technical employee type corresponds to an employee who spends the majority of time engaged in producing work products of an engineering or technical nature. An office operations employee type corresponds to an employee who spends the majority of their time engaged in administrative and support activities to managers, professional and technical employees. The EP-ROI tool 102 may further include other job types and their associated data.

Each of the employee types may have default data values for each of the business specific data values and each of the current performance estimate values. Table 2 shows the default business data values for the different employee types stored in the business specific data table 218.

TABLE 2

| | | | | Office |
|---|---|---|---|---|
| | Manager | Professional | Technical | Operations |
| Average cost to | 241% | 150% | 176% | 41% |
| hire/train new | | | | |
| employee (% of | | | | |
| base salary) | | | | |
| Average hourly | $140.00 | $100.00 | $50.00 | $70.00 |
| cost per | | | | |
| employee | | | | |
| (salary and | | | | |
| benefits) | | | | |
| Average annual | 2000 | 2000 | 2000 | 2000 |
| hours of work | | | | |
| time available | | | | |

In a professional/office workplace environment type, the average cost to hire/train a new employee business specific data value represents the average cost to the professional\office workplace environment to train or hire a new employee as a percentage of the base salary of a particular employee type. For example, the cost to a professional\office workplace environment typically to train an employee of a professional employee type costs 150% of the employees base salary. The average hourly cost per employee business specific data value represents the hourly cost to the professional\office workplace environment for the particular employee type. For example, an employee of a manager employee type costs a professional\office workplace environment $140.00 per hour. The average annual hours of work time available business specific data value represents the average amount of work hours available in a typical year.

Table 3 shows one example of default current performance estimate values for each of the various employee types stored in the business specific data table 218.

TABLE 3

| | | | | Office |
|---|---|---|---|---|
| | Manager | Professional | Technical | Operations |
| Process rework % | 5% | 15% | 20% | 2% |
| (iteration of work) | | | | |
| Average | 50% | 10% | 70% | 10% |
| percentage of time | | | | |
| spent in process | | | | |
| work | | | | |
| Average process | 1.00 | 2.00 | 10.00 | 1.00 |
| cycle time (Hrs) per | | | | |
| employee | | | | |
| Annual retention | 92% | 92% | 69% | 61% |
| rate (%) | | | | |
| Estimated Annual | $6,728.62 | $6,728.62 | $6,728.62 | $6,728.62 |
| Claim Amount per | | | | |
| Employee | | | | |

In one implementation, the average percentage of time spent in process work current performance estimate value represents the average amount of time spent performing work directly related to the primary role of that job type (for instance, an engineer working on a software program). The average process cycle time per employee current performance estimate value represents the average time (in minutes) of the process activity for that job type. The annual retention rate current performance estimate value represents the average annual retention rate for the job type. The estimate annual claim amount per employee current performance estimate value represents the average annual medical insurance costs per employee for the selected workplace environment type.

Although the business data module 204 may use the default business specific data values and the default current performance estimate values for each employee type, the business data module 204 may override the default business specific data values or current performance estimate values with other values. For example, the business data module 204 may receive one or more business specific data values for a technical employee type from the input device 104. As another example, the business data module 204 may receive one or more current performance estimate values for a professional employee type.

The business data module 204 is also operative to receive one or more values representing the number of persons for each employee type. For example, the business data module 204 may receive values indicating that a professional\office workplace environment has 5 employees of the manager employee type, 15 employees of the professional employee type, 8 employees of the technical employee type, and 45 employees of the office operations employee type. Alternatively, the business data module 204 may receive a value indicating that there no employees for a particular employee type. For example, the business data module 204 may receive values representing that the professional\office workplace environment has 10 employees of the manager employee type and 0 employees of the technical employee type.

The business data module 204 also computes a summation of the total number of employees for the professional\office workplace environment type. Using the total number of employees of the selected professional\office workplace environment type, the business data module 204 may then calculate overall business specific data values as an average of the business specific data values for each employee. Similarly, the business data module 204 may calculate overall current performance estimate values as an average of the current performance estimate values based on the total number of employees. The business data module 204 then transmits the average overall business specific data values and the average overall current performance estimate values to the predicted business outcome module 214.

Like the business data module 204, the project type selection module 206 is also in communication with the workplace environment type selection module 202. With the EP-ROI tool 102, each of the workplace environment types are associated with various project types. The project type selection module 206 is operative to receive a selected project type. In one implementation, the call center workplace environment type is associated with three different project types and the professional\office workplace environment type is associated with three different project types. Other workplace environment types may be associated with other project types. Examples of the three different project types for the call center workplace environment type include a small call center, a large call center, and new construction for a large call center. Examples of the three different project types for the professional\office workplace environment type include a small professional\office, a large professional\office, and new construction for a large professional\office. Other project types for the call center workplace environment type and the professional\office workplace environment type are also possible.

The project type selection module 206 is in communication with the workplace design feature investment amount module 208 and the predicted business outcome module 214, and is operative to transmit the selected project type to the workplace design feature investment amount module 208 and the predicted business outcome module 214. As explained further below, the selected project type affects the various workplace design feature investment amounts and the calculated predicted business outcome values.

The workplace design feature investment module 208 is operative to receive the selected project type from the project selection module 206 to facilitate determining initial workplace design feature investment amounts. As mentioned previously, the EP-ROI tool 102 uses investments in workplace design features to determine predicted business outcome values. In one implementation, the workplace design features for a call center workplace environment type may be similar to the workplace design features for a professional\office workplace environment type. Examples of workplace design features include the fit of workspace features for work needs in the workplace environment type, the comfort of the workplace environment type, the support for communication in the workplace environment type, the support for collaboration in the workplace environment type, the job/environmental control in the workplace environment type, and the support for sense of community in the workplace environment type. Other workplace design features are also possible.

Workplace design features describe various features of a workplace environment type. The fit of workplace features to work needs workplace design feature accounts for features including but not limited to: arrangement of furnishing, technology tools, size of worksurfaces, lighting, noise, storage, privacy, confidentiality of materials, and availability of support services. The comfort workplace design feature accounts for physical reactions to features including but not limited to: comfort of back, shoulders, arms, hands, eyes and legs. The support for communication workplace design feature accounts for such features as: access to co-workers for face to face communication, ease of accessing co-workers and supervisors, and ease of access to meeting spaces. The support for collaboration workplace design feature accounts for features including, but not limited to: availability of meeting space, meeting spaces have required layout, furnishings and technology, overall workspace permits quick shift from solo to group work, and effectiveness of small meeting rooms. The job/environmental control workplace design feature accounts for features and perceptions including but not limited to: ability to move and adjust features of the workstation, control over rate of speed of work, control over making decisions related to job tasks. The sense of community workplace design feature accounts for the extent to which workspace design contributes to a feeling of being part of the group, conveys appropriate image to employees, retains talented people, and degree to which workplace design makes employees feel valued. The workplace design features may account for other aspects of the workplace environment as well.

Each of the workplace design features may be associated with workplace components. The workplace components may be grouped in various categories. For example, the categories of the workplace components may include workstation furnishings components, technology components, facility interior design features components, and training and assessment workplace components. The workstation furnishing workplace component category may include an optimizing seating workplace component, an optimize workstation task light component, an optimize work surface area and shape component, an optimize side table component, an optimize keyboard/mouse tray component, an optimize storage component, and an optimize enclosure of the workstation component. The technology component category may include an optimize monitor component, an optimize docking station component, and an optimize technology in a meeting space component. The facility interior design features component category may include a create and/or optimize signage for way-finding component, an implement custom corporate graphics program component, an optimize meeting rooms component, and an enhance color, brightness, and texture of walls, floors, and doorways component. The training and assessment component category may include a provide workstation ergonomic assessment component and a provide ergonomic training component.

Table 4 shows the association between workplace design feature and workplace components. Each ‘X’ in Table 4 indicates that the workplace component is associated with a particular workplace design feature.

TABLE 4

| | | | | | | Support for |
|---|---|---|---|---|---|---|
| Workplace Design Feature/Workplace | Fit of Workspace | | Support for | Support for | Job/Environmental | Sense |
| Component | Features to Work Needs | Comfort | Communication | Collaboration | Control | of Community |
| Optimize Seating | X | X | | | X | |
| (enhance or replace) | | | | | | |
| Optimize Workstation Task Light | X | X | | | X | |
| (enhance or new) | | | | | | |
| Optimize Workstation Surface Area and | X | | | | | |
| Shape | | | | | | |
| Optimize Side Table | X | | | | | |
| (enhance or new) | | | | | | |
| Optimize Keyboard/Mouse Tray | X | X | | | X | |
| (upgrade or new) | | | | | | |
| Optimize Storage (shelves and filing) | X | | | | X | |
| (upgrade or new) | | | | | | |
| Optimize Enclosure of Workstation | | | X | | X | |
| (height and amount of enclosure) | | | | | | |
| Optimize Monitor | X | | | | X | |
| (upgrade or new) | | | | | | |
| Optimize Docking Station | | X | | | X | |
| (upgrade or new) | | | | | | |
| Optimize Technology in Meeting Space | | | | X | | |
| (upgrade or new) | | | | | | |
| Create and/or Optimize Signage for | | | X | | | X |
| Way-finding | | | | | | |
| Implement Custom Corporate Graphics | | | | | | X |
| Program | | | | | | |
| Optimize Meeting Rooms | | | X | X | | |
| (upgrading existing or add new) | | | | | | |
| Enhance Color, Brightness, and Texture | | | X | | | |
| of Walls, Floors, and Doorways | | | | | | |
| Provide Workstation Ergonomic | | | | | X | |
| Assessment | | | | | | |
| (To optimize workstation layout and | | | | | | |
| seating) | | | | | | |
| Provide Ergonomic Training | | | | | X | |
| (Teach employees how/why to make | | | | | | |
| adjustments to their equipment) | | | | | | |

Each of the workplace components are associated with an initial workplace component cost. The workplace component costs table 222 may store the initial workplace component costs. The initial workplace component costs vary depending on the selected workplace environment and the selected project type. Hence, there may be a set of workplace component costs for each of the different project types previously mentioned. For example, the small call center project type has a different set of component costs than the small professional/office type. However, the component costs for each of the project types may also be similar or equal.

Table 5 shows the workplace component costs of the workplace components for project types of the call center workplace environment type. The first row indicates the project type and the first column indicates the workplace component. The intersection of the first row and the first column indicates the component cost for the corresponding workplace component and the corresponding call center workplace environment type project type.

TABLE 5

| Project Type/ | Small Call Center | Large Call Center | Large Call Center (New |
|---|---|---|---|
| Workplace Component | (Refresh/Remodel) | (Refresh/Remodel) | Construction) |
| Optimize Seating | $650.00 | $650.00 | $550.00 |
| (enhance or replace) | | | |
| Optimize Workstation Task | $125.00 | $125.00 | $125.00 |
| Light | | | |
| (enhance or new) | | | |
| Optimize Work Surface Area | $750.00 | $750.00 | $750.00 |
| and Shape | | | |
| Optimize Side Table | $0.00 | $0.00 | $0.00 |
| (enhance or add new) | | | |
| Optimize Keyboard/Mouse Tray | $250.00 | $250.00 | $250.00 |
| (upgrade or new) | | | |
| Optimize Storage (Shelves and | $300.00 | $300.00 | $300.00 |
| Filing) | | | |
| (upgrade or new) | | | |
| Optimize Enclosure of | $1,000.00 | $1,000.00 | $1,000.00 |
| Workstation | | | |
| (height and amount of | | | |
| enclosure) | | | |
| Optimize Monitor | $500.00 | $500.00 | $500.00 |
| (upgrade or new) | | | |
| Optimize Docking Station | $150.00 | $150.00 | $150.00 |
| (upgrade or new) | | | |
| Optimize Technology in | $500.00 | $500.00 | $500.00 |
| Meeting Space | | | |
| (upgrade or new) | | | |
| Create and/or Optimize Signage | $80.00 | $80.00 | $80.00 |
| for Way-finding | | | |
| Implement Custom Corporate | $100.00 | $125.00 | $125.00 |
| Graphics Program | | | |
| Optimize Meeting Rooms | $300.00 | $200.00 | $200.00 |
| (upgrade existing or add new) | | | |
| Enhance Color, Brightness and | $50.00 | $50.00 | $50.00 |
| Texture of Walls, Floors and | | | |
| Doorways | | | |
| Provide Workstation | $100.00 | $100.00 | $100.00 |
| Ergonomic Assessment | | | |
| (To optimize workstation layout | | | |
| and seating) | | | |
| Provide Ergonomic Training | $100.00 | $100.00 | $100.00 |
| (Teach employees how/why to | | | |
| make adjustments to their | | | |
| equipment) | | | |

Table 6 shows the workplace component costs of the workplace components for project types of the professional/office workplace environment type. The first row indicates the project type and the first column indicates the workplace component. The intersection of the first row and the first column indicates the component cost for the corresponding workplace component and the corresponding professional/office workplace environment type project type.

TABLE 6

| | Small | Large | Large |
|---|---|---|---|
| Project Type/ | Professional/Office | Professional/Office | Professional/Office |
| Workplace Component | (Refresh/Remodel) | (Refresh/Remodel) | (New Construction) |
| Optimize Seating | $650.00 | $550.00 | $550.00 |
| (enhance or replace) | | | |
| Optimize Workstation Task | $125.00 | $125.00 | $125.00 |
| Light | | | |
| (enhance or new) | | | |
| Optimize Work Surface Area | $1,050.00 | $1,050.00 | $1,050.00 |
| and Shape | | | |
| Optimize Side Table | $400.00 | $300.00 | $300.00 |
| (enhance or add new) | | | |
| Optimize Keyboard/Mouse Tray | $250.00 | $250.00 | $250.00 |
| (upgrade or new) | | | |
| Optimize Storage (Shelves and | $1,300.00 | $1,150.00 | $1,150.00 |
| Filing) | | | |
| (upgrade or new) | | | |
| Optimize Enclosure of | $2,000.00 | $2,000.00 | $2,000.00 |
| Workstation | | | |
| (height and amount of | | | |
| enclosure) | | | |
| Optimize Monitor | $500.00 | $500.00 | $500.00 |
| (upgrade or new) | | | |
| Optimize Docking Station | $150.00 | $150.00 | $150.00 |
| (upgrade or new) | | | |
| Optimize Technology in | $500.00 | $500.00 | $500.00 |
| Meeting Space | | | |
| (upgrade or new) | | | |
| Create and/or Optimize Signage | $80.00 | $80.00 | $80.00 |
| for Way-finding | | | |
| Implement Custom Corporate | $125.00 | $125.00 | $125.00 |
| Graphics Program | | | |
| Optimize Meeting Rooms | $300.00 | $200.00 | $200.00 |
| (upgrade existing or add new) | | | |
| Enhance Color, Brightness and | $50.00 | $50.00 | $50.00 |
| Texture of Walls, Floors and | | | |
| Doorways | | | |
| Provide Workstation | $100.00 | $100.00 | $100.00 |
| Ergonomic Assessment | | | |
| (To optimize workstation layout | | | |
| and seating) | | | |
| Provide Ergonomic Training | $100.00 | $100.00 | $100.00 |
| (Teach employees how/why to | | | |
| make adjustments to their | | | |
| equipment) | | | |

When the workplace design feature investment module 208 receives the selected project type from the project selection module 206, the workplace design feature investment module may transmit the selected project type to the workplace component cost module 210. The workplace component cost module 210 is in communication with the component costs table 222 of the database 118. The workplace component cost module 210 is operative to retrieve a set of initial workplace component costs corresponding to the selected project type received from the workplace design feature investment module 208. For example, where the selected project type is the small professional/office project type, the workplace component cost module 210 retrieves the set of workplace component costs corresponding to the small professional/office type. The workplace component cost module 210 may then transmit the initial workplace component costs to the workplace design feature investment module 208.

Alternatively to sending initial workplace component costs to the workplace design feature investment module 208, the workplace component cost module 210 may adjust one or more workplace component cost amounts. Adjusting a workplace component cost amount may include increasing or decreasing the workplace component cost amount. For example, the workplace component cost module 210 may increase the initial cost amount of the optimizing seating component cost for a small center project type from $650.00 to $750.00. Alternatively, the workplace component cost module 210 may decrease the initial cost amount of the optimizing seating component for a small center project type from $650.00 to $500.00. The workplace component cost module 210 may further adjust or re-adjust the workplace component cost amount after adjusting the initial cost of the workplace component cost amount.

The workplace component cost module 208 is operative to calculate initial workplace design feature investment amounts using the workplace component cost amounts. In one implementation, initial workplace design feature investment amounts correspond to a summation of associated workplace component cost amounts.

For example, in one implementation where the selected workplace environment type is a cell center workplace environment type, and the selected project type is a small call center project type, an initial workplace design feature investment amount for the fit of workspace features to design work needs investment amount is $2,575.00. In this example, the fit of workspace features to design work needs investment amount corresponds to the summation of the optimize seating component cost amount of $650.00, the optimize workstation task light component cost amount of $125.00, the optimize work surface area and shape component cost amount of $750.00, the optimize side table component cost amount of $0.00, the optimize keyboard/mouse tray component cost amount of $250.00, the optimize storage component cost amount of $300.00, and the optimize monitor component cost amount of $500.00. Other implementations for computing an initial workplace design feature investment amount are also possible.

The workplace component cost amount module 210 is operative to communicate the initial workplace design feature investment amounts to the workplace design feature investment amount module 208. The workplace design feature investment amount module 208 is operative to adjust one or more workplace design feature investment amounts. Adjusting a workplace design feature investment amount may include increasing or decreasing a workplace design feature investment amount. For example, the workplace design feature investment amount module 208 may adjust an initial workplace design feature investment amount using an investment amount adjustment. The investment amount adjustment may be measured in incremented or decremented costs of the initial workplace feature design investment amount, percentages of increase or decrease of the initial workplace feature design investment amount, or other amounts. As an example, the design feature investment amount module 208 may increase the initial workplace design feature investment amount for the fit of workspace features to design work needs workplace design feature by 10%. Supposing that the initial fit of workspace features to design work needs workplace feature investment amount is $2,575.00, an increase of 10% would increase this initial workplace design feature investment amount by $257.50. The 10% increase represents the investment amount adjustment.

In one embodiment of the EP-ROI tool 102, adjusting a workplace design feature investment amount causes an adjustment in one or more workplace component cost amounts. As the workplace design feature investment module 208 is in communication with the workplace component cost module 210, the workplace design feature investment module 208 is operative to communicate an indication that an adjustment was made in a workplace design feature investment amount to the workplace component cost module 210. The workplace component cost module 210 then adjusts the cost amount of a workplace component cost based on whether an adjustment was made to an associated workplace design feature investment amount, and the number of workplace design features associated with the workplace component cost. The workplace component cost module 210 may adjust one cost amount of a workplace component cost or the workplace component cost module 210 may adjust multiple cost amounts of workplace component costs. In one embodiment, the workplace component cost module 210 computes an adjusted component cost amount by dividing the workplace component cost amount by the number of associated workplace design feature investment amounts that were adjusted.

For example, the optimize seating workplace component cost is associated with three workplace design features: the fit of workspace features to work needs workplace design feature, the comfort workplace design feature, and the job/environmental control workplace design feature. For a small call center project type, the initial cost amount of the optimize seating workplace component is $650.00. When only the fit of workspace features to design needs investment amount is adjusted, the workplace component cost module 210 divides the optimize seating workplace component cost amount by 1. Hence, the adjusted component cost amount of the optimize seating workplace component remains $650.00. When the workspace features to design needs investment amount and the comfort investment amount are adjusted, the workplace component cost module 210 divides the fit of workspace features to design needs component cost amount by 2. Hence, the adjusted component cost amount of the optimize seating workplace component cost amount is $325.00. When the workspace features to design needs investment amount, the comfort investment, and the job/environment control investment amount are adjusted, the workplace component cost module 210 divides the fit of workspace features to design needs investment amount by 3. Hence, the adjusted component cost of the optimize seating workplace component cost amount is $216.67

In addition, and using the previous example, because the fit of workspace features to work needs workplace design feature, the comfort workplace design feature, and the job/environment control workplace design feature are also associated with other workplace components, the workplace component cost module 210 also adjusts the component cost amounts for the other associated workplace components. Thus, when these three workplace design features are adjusted, the workplace component cost module 210 also divides the initial component cost amount of the optimize workstation task light component and the optimize keyboard/mouse tray component by three. However, other component cost amounts, such as the optimize storage cost amount, are divided by two. The optimize storage cost amount is divided by two because it is associated with the fit of workspace features to design needs workplace design feature and the job/environmental control workplace design feature, and in this embodiment, not with the comfort workplace design feature. However, in other implementations, the storage cost amount may be associated with the comfort workplace design feature. Hence, depending on the number of adjusted workplace design feature investment amounts and their association to workplace component cost amounts, the workplace component cost module 210 may adjust none, one, or multiple workplace component cost amounts.

In addition to facilitating the adjustment of workplace design feature investment amounts, the workplace design feature module 208 also determines other amounts. Other amounts determined by the workplace design feature module 208 include incremental investment amounts, projected cost amounts, and a total cost amount.

In one implementation, the workplace design feature investment module 208 determines an incremental investment amount for each workplace design feature. The workplace design feature investment module 208 may determine the incremental investment amount using an investment amount adjustment and a corresponding workplace design feature investment amount. For example, supposing a small call center project type, the workplace design feature investment module 208 may determine an incremental investment amount of $412.50 where the investment amount adjustment is 20% and the fit of workspace features to work needs investment amount is $2,062.50.

In another implementation, the workplace design feature investment module 208 determines a projected cost amount for each workplace design feature. The workplace design feature investment module 208 may determine the projected cost by multiplying an incremental investment amount and a value representing the number employees for the workplace environment. For example, supposing a call center workplace environment having forty-five call center agents and a small call center project type, the workplace design feature investment module 208 calculates a projected cost of $18,563 for the fit of workspace features for work needs workplace design feature where the increment investment amount is $412.50. The workplace design feature investment module 208 may also calculate projected costs for each of the other workplace design features as well.

Using the calculated projected costs, the workplace design feature investment module 208 may also determine a total cost for the selected project type. In one implementation, the workplace design feature investment module 208 determines the total cost for the selected project type as a summation of the projected costs for each of the workplace design features. Other methods for determining total cost are also possible.

The workplace design feature investment module 208 and the workplace component cost module 210 communicate the various aforementioned amounts to the predicted business outcome module 214. The predicted business outcome module 214 is operative to calculate predicted business outcome values using the received workplace design feature investment amounts and the selected project type. Each of the calculated predicted business outcome values are associated with a predicted business outcome. The predicted business outcome values may be stored in or retrieved from the predicted business outcome data table 224.

There are many possible predicted business outcomes. In one implementation, the predicted business outcomes vary between project types. Alternatively, the predicted business outcomes may vary between workplace environment types. For example, the call center workplace environment type may have a different set of predicted business outcomes than the professional\office workplace environment type. Other environment types may also have different predicted business outcomes.

In one embodiment, the call center workplace environment has four categories of predicted business outcomes for each of the project types associated with the call center workplace environment type. In this embodiment, the categories of predicted business outcomes include after call work predicted business outcomes, first call resolution predicted business outcomes, retention predicted business outcomes, and health and safety claims cost predicted business outcomes. Each of the four categories may include one or more predicted business outcomes.

The category of after call work predicted business outcomes includes various predicted outcomes directed to the amount of time a call center agent spends completing work resulting from the most recently completed customer call. Examples of predicted business outcomes in the after call work predicted business outcome category include, but are not limited to, a potential after call work predicted business outcome, an after call seconds saved per call predicted business outcome, a total after call seconds saved per day predicted business outcome, a total after call hours saved per day predicted business outcome, a total cost saved per day predicted business outcome, and an estimated annual after call work savings predicted business outcome.

The category of first call resolution predicted business outcomes includes predicted business outcomes directed to the average percentage of customer calls in which a request for assistance from a customer can be completed as a part of an initial call. Examples of predicted business outcomes in the first call resolution predicted business outcome category include, but are not limited to, a total calls per day predicted business outcome, a possible first call resolution rate predicted business outcome, a current unresolved calls per day predicted business outcome, a possible unresolved calls per day predicted business outcome, a possible decrease in unresolved calls per day predicted business outcome, a total cost saved per day predicted business outcome, and an estimated annual retention savings predicted business outcome.

The category of retention predicted business outcomes includes predicted outcomes directed to the average annual retention rate for employees. Examples of predicted business outcomes in the retention rate predicted business outcome category include, but are not limited to a possible retention rate predicted business outcome, a current annual replacement required predicted business outcome, a possible annual replacement required predicted business outcome, a possible annual hiring reduction predicted business outcome, an annual cost to train new agent predicted business outcome, and an estimated annual retention savings predicted business outcome.

The health and safety claims cost predicted business outcome category includes predicted business outcomes directed to the average annual per person medical insurance claims cost. Examples of predicted business outcomes in the health and safety claims cost predicted business outcome category include a predicted claims cost per agent predicted business outcome and an estimated annual health and safety claims savings predicted business outcome.

In one implementation, the predicted business outcome module 214 uses regression coefficients and investment amount adjustments measured in percentage to determine one or more predicted business outcome values for the call center workplace environment type. For example, the predicted business outcome module 214 may calculate the potential after call work value, the possible first call resolution rate value, the possible retention rate value, and the predicted claims per agent value, using regression coefficients and the investment amount adjustments. In one embodiment, the regression coefficients are stored in and retrieved from the predicted business outcome data table 224.

Each of the project types of the call center workplace environment type may have one or more associated regression coefficients. Table 7 shows examples of regression coefficients used by the predicted business outcome module 214 in determining various predicted business outcomes for the call center workplace environment type.

TABLE 7

| Workplace Design Feature/ | Fit of Workspace | | | | | |
|---|---|---|---|---|---|---|
| Type of Regression | Features to Work | | Support for | Support for | Job/Environmental | Support for Sense |
| Coefficient | Needs | Comfort | Communication | Collaboration | Control | of Community |
| Retention (%) | −0.24 | 0 | 0 | 0 | 0.19 | 0.21 |
| Customer Service (1-10) | 0.1 | 0.11 | 0 | 0 | 0.32 | −0.18 |
| After Call Worktime | 0 | −0.17 | 0 | 0 | 0 | 0.2 |
| (Minutes) | | | | | | |
| First Call Resolution (%) | 0 | 0 | 0 | 0.1 | 0 | 0 |
| Claims/Employee | −0.08 | −0.01 | −0.02 | 0.00 | −0.01 | 0.02 |
| Claim Amount | −12656.71 | −2214.93 | −3055.07 | 0.00 | −1926.02 | 0.00 |

Alternatively, the predicted business outcome module 214 may use adjusted regression coefficients in determining one or more predicted business outcomes for the call center workplace environment type. Table 8 shows examples of adjusted regression coefficients used by the predicted business outcome module 214 in determining various predicted business outcomes for the call center workplace environment type.

TABLE 8

| Workplace Design Feature/ | Fit of Workspace | | | | | |
|---|---|---|---|---|---|---|
| Type of Regression | Features to Work | | Support for | Support for | Job/Environmental | Support for Sense |
| Coefficient | Needs | Comfort | Communication | Collaboration | Control | of Community |
| Retention (%) | −0.0024 | 0 | 0 | 0 | 0.0019 | 0.0021 |
| Customer Service (1-10) | 0.1 | 0.11 | 0 | 0 | 0.32 | −0.18 |
| After Call Worktime | 0 | −0.17 | 0 | 0 | 0 | 0.2 |
| (Minutes) | | | | | | |
| First Call Resolution (%) | 0 | 0 | 0 | 0.01 | 0 | 0 |
| Claims/Employee | −0.0008 | −0.0001 | −0.0002 | 0.0000 | −0.0001 | 0.0002 |
| Claim Amount | −15.82 | −2.77 | −3.82 | 0.00 | −2.41 | 0.00 |

In one embodiment, and starting with the after call work predicted business outcome category for the call center workplace environment type, the predicted business outcome module 214 first determines the possible after call work value. Equation 1 shows one equation for determining the possible after call work value using regression coefficients from the after call worktime row of Table 8.

$${P}_{a c} = {\sum }_{n = 1}^{6} ( {a}_{n} \times {IA}_{n} ) + {C}_{a c} and if ( {P}_{a c} < 0 ) then {P}_{a c} = 0. \qquad ( eq . 1 )$$

where:
P_{ac} is the possible after call work value;
a₁ is the fit of workspace features to work needs regression coefficient value;
a₂ is the comfort regression coefficient value;
a₃ is the support for communication regression coefficient value;
a₄ is the support for collaboration regression coefficient value;
a₅ is the job/environmental control regression coefficient value;
a₆ is the support for sense of community regression coefficient value;
IA₁ is the investment amount adjustment for the fit of workspace features to work needs workplace design feature;
IA₂ is the investment amount adjustment for the comfort workplace design feature;
IA₃ is the investment amount adjustment for the support for communication workplace design feature;
IA₄ is the investment amount adjustment for the support for collaboration workplace design feature;
IA₅ is the investment amount adjustment for the job/environment control workplace design feature;
IA₆ is the investment amount adjustment for the support for sense of community workplace design feature;
C_{ac} is the current performance estimate after call work value; and,
IAₙ is a value between 0 and 10, inclusive.

Using the possible after call work value, the predicted business outcome module 214 calculates the additional predicted business outcome values in the after call work predicted business outcome category. The predicted business outcome module 214 determines the after call seconds saved per call value by subtracting the possible after call work value from the current performance estimate after call work value. The predicted business outcome module 214 also determines the total after call seconds saved per day value by multiplying together the value of the number of call center agents, the average calls per day per agent business specific data value, and the after call seconds saved per call value. In one implementation, the predicted business outcome module 214 determines the total after call hours saved per day value by dividing the total after call seconds save per day value by 3600. The predicted business outcome module 214 further determines the total cost saved per day value by multiplying the total after call hours saved per day value with the average hourly cost per average agent business specific data value. The predicted business outcome module 214 may then determine estimated annual after call work savings value by multiplying the total cost saved per day value by the number of working days per year, such as 260 working days per year. The predicted business outcome module 214 may then store each of these values in the predicted business outcome data table 224.

In addition, the predicted business outcome module 214 may determine the possible first call resolution rate value using regression coefficients from the retention row of Table 8. Equation 2 shows one equation for determining the possible first call resolution rate value.

$${P}_{fcr} = {\sum }_{n = 1}^{6} ( {b}_{n} \times {IA}_{n} ) + {C}_{fcr} and \\ if ( {P}_{fcr} < 0 ) then {P}_{fcr} = 0 ; and , \\ if ( {P}_{fcr} > {C}_{fcr} + \frac{1 - {C}_{fcr}}{2} ) then {P}_{fcr} = {C}_{fcr} + \frac{1 - {C}_{fcr}}{2} \qquad ( eq . 2 )$$

where:
P_{fcr} is the possible first call resolution value;
b₁ is the fit of workspace features to work needs regression coefficient value;
b₂ is the comfort regression coefficient value;
b₃ is the support for communication regression coefficient value;
b₄ is the support for collaboration regression coefficient value;
b₅ is the job/environmental control regression coefficient value;
b₆ is the support for sense of community regression coefficient value;
IA₁ is the investment amount adjustment for the fit of workspace features to work needs workplace design feature;
IA₂ is the investment amount adjustment for the comfort workplace design feature;
IA₃ is the investment amount adjustment for the support for communication workplace design feature;
IA₄ is the investment amount adjustment for the support for collaboration workplace design feature;
IA₅ is the investment amount adjustment for the job/environment control workplace design feature;
IA₆ is the investment amount adjustment for the support for sense of community workplace design feature;
C_{fcr} is the current performance estimate first call resolution value; and,
IAₙ is a value between 0 and 10, inclusive.

Using the possible first call resolution rate value, the predicted business outcome module 214 calculates the additional predicted business outcome values in the first call resolution predicted business outcome category. The predicted business outcome module 214 determines the possible unresolved calls per day value by subtracting the number of possible unresolved calls per day from the total calls per day value. The total calls per day value may be determined by multiplying the number of call center agents by the number of average calls per day per call center agent. In one implementation, the predicted business outcome module 214 determines the current unresolved calls per day value by subtracting the number of current unresolved calls per day from the total calls per day value. The predicted business outcome module 214 may further determine the possible decrease in unresolved calls per day value by subtracting the possible unresolved calls per day value from the current unresolved calls per day value. The predicted business outcome module 214 may also determine the total cost saved per day predicted outcome value by multiplying the possible decrease in unresolved calls per day predicted outcome value by the cost per call not resolved on first contact business specific data value. In one implementation, the predicted business outcome module 214 determines the estimated annual first call resolution savings value by multiplying the total cost saved per day predicted business outcome value by the number of days per year.

Furthermore, the predicted business outcome module 214 may determine the possible retention rate value using regression coefficients from the retention row of Table 8. Equation 3 shows one equation for determining the possible retention rate value.

$${P}_{rr} = {\sum }_{n = 1}^{6} ( {c}_{n} \times {IA}_{n} ) + {C}_{rr} and \\ if ( {P}_{rr} < 0 ) then {P}_{rr} = 0 ; and , \\ if ( {P}_{rr} > {C}_{rr} + \frac{1 - {C}_{rr}}{2} ) then {P}_{rr} = {C}_{rr} + \frac{1 - {C}_{rr}}{2} \qquad ( eq . 3 )$$

where:
Pᵣᵣ is the possible retention rate value;
c₁ is the fit of workspace features to work needs regression coefficient value;
c₂ is the comfort regression coefficient value;
c₃ is the support for communication regression coefficient value;
c₄ is the support for collaboration regression coefficient value;
c₅ is the job/environmental control regression coefficient value;
c₆ is the support for sense of community regression coefficient value;
IA₁ is the investment amount adjustment for the fit of workspace features to work needs workplace design feature;
IA₂ is the investment amount adjustment for the comfort workplace design feature;
IA₃ is the investment amount adjustment for the support for communication workplace design feature;
IA₄ is the investment amount adjustment for the support for collaboration workplace design feature;
IA₅ is the investment amount adjustment for the job/environment control workplace design feature;
IA₆ is the investment amount adjustment for the support for sense of community workplace design feature;
Cᵣᵣ is the annual retention rate current performance estimate value; and,
IAₙ is a value between 0 and 10, inclusive.

Using the possible retention rate value, the predicted business outcome module 214 calculates the additional predicted business outcome values in the retention rate predicted business outcome category. The predicted business outcome module 214 determines the possible annual replacement required value by subtracting the possible retention rate value from 100 and multiplying the result by the number of call center agents. The predicted business outcome module 214 also determines a current annual replacement required value by subtracting the current retention rate value from one and multiplying the result by the number of call center agents. In addition the predicted business outcome module 214 determines the possible annual hiring reduction value by subtracting the predicted possible annual replacement value from the current annual replacement required value. In one implementation, the possible annual hiring reduction value is negative. Furthermore, the predicted business outcome module 214 determines the annual cost to train new agent value by multiplying several values, including the average hourly cost per average agent the number of hours in a typical working day, the number of days in a typical working year and the cost to hire and train new agent value. In one implementation, the predicted business outcome module 214 determines the estimated annual retention savings value by multiplying the annual cost to train new agent value by the possible annual hiring reduction value.

Additionally, the predicted business outcome module 214 may further determine the predicted claims cost per agent value using regression coefficients from the claim amount row shown in Table 8. Equation 4 shows one equation for calculating the predicted claims cost per agent value.

$${P}_{cc} = {\sum }_{n = 1}^{6} ( {d}_{n} \times {IA}_{n} ) + {C}_{cc} and \\ if ( {P}_{cc} < \frac{{C}_{cc}}{2} ) then {P}_{cc} = \frac{{C}_{cc}}{2} \qquad ( eq . 4 )$$

where:
P_{cc} is the predicted claims cost per agent value;
d₁ is the fit of workspace features to work needs regression coefficient value;
d₂ is the comfort regression coefficient value;
d₃ is the support for communication regression coefficient value;
d₄ is the support for collaboration regression coefficient value;
d₅ is the job/environmental control regression coefficient value;
d₆ is the support for sense of community regression coefficient value;
IA₁ is the investment amount adjustment for the fit of workspace features to work needs workplace design feature;
IA₂ is the investment amount adjustment for the comfort workplace design feature;
IA₃ is the investment amount adjustment for the support for communication workplace design feature;
IA₄ is the investment amount adjustment for the support for collaboration workplace design feature;
IA₅ is the investment amount adjustment for the job/environment control workplace design feature;
IA₆ is the investment amount adjustment for the support for sense of community workplace design feature;
C_{cc} is the current claims cost per agent value; and,
IAₙ is a value between 0 and 10, inclusive.

Using the predicted claims cost per agent value, the predicted business outcome module 214 calculates additional predicted business outcome values in the health and safety claims cost predicted business outcome category. For example, the predicted business outcome module 214 determines the estimated annual health and safety claims savings value by subtracting the predicted claims cost per agent value from the current claims cost per agent value.

The predicted business outcome module 214 may also determine predicted business outcome values not assigned to a predicted business outcome category. For example, the predicted business outcome module 214 may determine a total savings for the selected project type as a summation of each of estimated annual savings from each of the predicted business outcome categories. The total savings for the selected project type may be a positive value or a negative value. The predicted business outcome module 214 may further determine a first year cumulative return on investment value for the selected project type as a summation of the total cost for the selected project type and the total savings for the selected project type. A second year cumulative return on investment value may be determined as a summation of the first year cumulative return on investment value and the total savings for the selected project type. Similarly, a third year cumulative return on investment value may be determined as a summation of the second year cumulative return on investment value and the total savings for the selected project type. Additional cumulative return on investment values may be further determined accordingly.

In one embodiment, the predicted business outcome module 214 communicates with the reporting module 216 to output the predicted business outcome values to the output device 114. Examples of outputting the predicted business outcome values include displaying the predicted business outcome values on a display device or by writing the predicted business outcome values to a file as a part of a storage device. Alternatively, or in addition to communicating the predicted business outcome values to the reporting module 216, the predicted business outcome module 214 216 may store one or more predicted business outcome values in the predicted business outcome data table 224. The predicted business outcome values may be later retrieved from the predicted business outcome data table 224 using an associated customer identifier.

Although the workplace design feature investment amount module 208 may adjust the workplace design feature investment amounts, the workplace design feature investment amount module 208 may communicate the workplace design feature investment amounts to the optimization module 212 for further or additional adjusting. In one implementation, the optimization module 212 is operative to adjust one or more workplace design feature investment amounts according to the optimization of a predicted business outcome. In particular, the optimization module 212 is operative to minimize the possible after call work value, to maximize the possible first call resolution rate value, to maximize the possible retention rate value, and to minimize the predicted claims cost per agent value. The optimization module 212 may further communicate with the reporting module 216 to display charts or graphs that illustrate effect of optimizing a predicted business outcome value.

Optimizing a predicted business outcome value may affect the investment amount in one or more workplace design features. Table 9 shows the affects on the workplace design feature investment amounts when an associated predicted business outcome value is optimized.

TABLE 9

| Optimization/ | | | | |
|---|---|---|---|---|
| Workplace Design | Minimize Possible | Maximize Possible | Maximize Possible | Minimize Predicted |
| Feature Investment | After Call Work | First Call Resolution | Retention Rate | Claims Cost Per |
| Amount Adjustment | Value | Rate Value | Value | Agent Value |
| Fit of Workspace | 0% | 0% | 0% | 40% |
| Features to Work | | | | |
| Needs | | | | |
| Comfort | 40% | 0% | 0% | 40% |
| Support for | 0% | 0% | 0% | 40% |
| Communication | | | | |
| Support for | 0% | 40% | 0% | 0% |
| Collaboration | | | | |
| Job/Environmental | 0% | 0% | 40% | 40% |
| Control | | | | |
| Support for Sense | 0% | 0% | 40% | 0% |
| of Community | | | | |

As previously discussed, the predicted business outcomes vary between project types. As an additional example in implementing the EP-ROI tool 102, the professional\office workplace environment type may have a different set of predicted business outcomes than the call center workplace environment type.

In one embodiment, the professional\office environment has four categories of predicted business outcomes for each of the project types associated with the professional\workplace environment type: rework predicted business outcomes, process cycle time predicted business outcomes, retention predicted business outcomes, and health and safety claims cost predicted business outcomes. Each of the four categories may include one or more predicted business outcomes.

The category of rework predicted business outcomes includes various predicted outcomes directed to the average percentage of work that is repeated due to errors, refinements or other required iterations. Examples of predicted business outcomes in the rework predicted business outcome category include, but are not limited to, a possible rework predicted business outcome, a total process work hours per employee predicted business outcome, a current total rework hours per employee predicted business outcome, a possible total rework hours per employee predicted business outcome, a total rework hours saved per employee predicted business outcome, and an estimated annual rework savings predicted business outcome.

The category of process cycle time predicted business outcomes includes predicted business outcomes directed to the average duration of a typical work process. Examples of predicted business outcomes in the process cycle time predicted business outcome category include, but are not limited to, a possible process time per employee predicted business outcome, a process cycle time saved predicted business outcome, a current processes per employee year predicted business outcome, a possible processes per employee year predicted business outcome, an increased processes per employee year predicted business outcome, an employee work hours saved per year predicted business outcome, and an estimated annual process cycle time savings predicted business outcome.

The category of retention predicted business outcomes includes, but is not limited to, a possible retention rate predicted business outcome, a current annual replacement required predicted business outcome, a possible annual replacement required predicted business outcome, a possible annual hiring reduction predicted business outcome, an annual cost to train new employee predicted business outcome, and an estimated annual retention savings predicted business outcome.

The health and safety claims cost predicted business outcome category includes a predicted claims cost per employee predicted business outcome and an estimated annual health and safety claims savings predicted business outcome.

In one implementation, the predicted business outcome module 214 uses regression coefficients and investment amount adjustments measured in percentage to determine one or more predicted business outcome values for the professional\office workplace environment type. For example, the predicted business outcome module 214 may calculate the potential rework value, the possible process time per employee value, the possible retention rate value, and the predicted claims per agent value, using regression coefficients and the investment amount adjustments. In one embodiment, the regression coefficients are stored in and retrieved from the predicted business outcome data table 224.

Each of the project types of the professional\office workplace environment type may have one or more associated regression coefficients. Table 10 shows examples of regression coefficients used by the predicted business outcome module 214 in determining various predicted business outcomes for the professional\office workplace environment type.

TABLE 10

| Workplace Design Feature/ | Fit of Workspace | | | | | |
|---|---|---|---|---|---|---|
| Type of Regression | Features to Work | | Support for | Support for | Job/Environmental | Support for Sense |
| Coefficient | Needs | Comfort | Communication | Collaboration | Control | of Community |
| Retention (%) | −0.24 | 0 | 0.2 | 0 | 0.19 | 0.21 |
| Output Quality | 0.1 | 0.11 | 0 | 0 | 0.32 | −0.18 |
| Process Cycle Time (Hr) | −0.33 | 0 | −0.23 | −0.3 | 0 | 0 |
| Rework (%) | 0 | 0 | 0 | 0 | −0.23 | 0 |
| Claims/Employee | −0.08 | −0.01 | −0.02 | 0.00 | −0.01 | 0.02 |
| Claim Amount | −12656.71 | −2214.93 | −3055.07 | 0.00 | −1926.02 | 0.00 |

Alternatively, the predicted business outcome module 214 may use adjusted regression coefficients in determining one or more predicted business outcomes for the professional\office workplace environment type. Table 11 shows examples of adjusted regression coefficients used by the predicted business outcome module 214 in determining various predicted business outcomes for the professional\office workplace environment type.

TABLE 11

| Workplace Design Feature/ | Fit of Workspace | | | | | |
|---|---|---|---|---|---|---|
| Type of Regression | Features to Work | | Support for | Support for | Job/Environmental | Support for Sense |
| Coefficient | Needs | Comfort | Communication | Collaboration | Control | of Community |
| Retention (%) | −0.0024 | 0 | 0.002 | 0 | 0.0019 | 0.0021 |
| Output Quality | 0.1 | 0.11 | 0 | 0 | 0.32 | −0.18 |
| Process Cycle Time (Hr) | −0.0033 | 0 | −0.0023 | −0.003 | 0 | 0 |
| Rework (%) | 0 | 0 | 0 | 0 | −0.023 | 0 |
| Claims/Employee | −0.0792 | −0.0139 | −0.0191 | 0.0000 | −0.0121 | 0.0002 |
| Claim Amount | −1265.67 | −221.49 | −305.51 | 0.00 | −192.60 | 0.00 |

In one embodiment, and starting with the rework predicted business outcome category for the professional\office workplace environment type, the predicted business outcome module 214 first determines the possible rework value. Equation 5 shows one equation for determining the possible rework value using regression coefficients from the rework row of Table 11.

$${P}_{rw} = {\sum }_{n = 1}^{6} ( {e}_{n} \times {IA}_{n} ) + {C}_{rw} and \\ if ( {P}_{rw} < \frac{{C}_{rw}}{2} ) then {P}_{rw} = \frac{{C}_{rw}}{2} \qquad ( eq . 5 )$$

where:
P_{rw} is the possible rework value;
e₁ is the fit of workspace features to work needs regression coefficient value;
e₂ is the comfort regression coefficient value;
e₃ is the support for communication regression coefficient value;
e₄ is the support for collaboration regression coefficient value;
e₅ is the job/environmental control regression coefficient value;
e₆ is the support for sense of community regression coefficient value;
IA₁ is the investment amount adjustment for the fit of workspace features to work needs workplace design feature;
IA₂ is the investment amount adjustment for the comfort workplace design feature;
IA₃ is the investment amount adjustment for the support for communication workplace design feature;
IA₄ is the investment amount adjustment for the support for collaboration workplace design feature;
IA₅ is the investment amount adjustment for the job/environment control workplace design feature;
IA₆ is the investment amount adjustment for the support for sense of community workplace design feature;
C_{rw} is the overall current performance estimate rework value; and,
IAₙ is a value between 0 and 10, inclusive.

Using the possible rework value, the predicted business outcome module 214 determines the additional predicted business outcome values in the rework predicted business outcome category. The predicted business outcome module 214 determines the possible total rework hours per employee value by multiplying the possible rework value by the total process work hours per employee value. The predicted business outcome module 214 determines the total process work hours per employee value by multiplying the overall average annual hours of work time available business specific data value by the overall average percentage of time spent in process work current performance estimate value. The predicted business outcome module 214 further determines current total rework hours per employee value by multiplying the total process work hours per employee value by the process rework current performance estimate value. In addition, the predicted business outcome module 214 determines the total rework hours saved per employee value by subtracting the possible total rework hours per employee value from the current total rework hours per employee value. Finally, the predicted business outcome module 214 determines the estimated annual rework savings value by multiplying together the number of employees in the professional\office environment type, the overall average hourly cost per employee business specific data value, and the total rework hours saved per employee value. The predicted business outcome module 214 may then store each of these values in the predicted business outcome data table 224.

In addition, the predicted business outcome module 214 may determine the possible process time per employee value using regression coefficients from the process cycle time row of Table 11. Equation 6 shows one equation for determining the possible process time per employee value.

$${P}_{p t} = {\sum }_{n = 1}^{6} ( {f}_{n} \times {IA}_{n} ) + {C}_{p t} and \\ If ( {P}_{p t} < \frac{{C}_{p t}}{1.5} ) then {P}_{p t} = \frac{{C}_{p t}}{1.5} \qquad ( eq . 6 )$$

where:
Pₚₜ is the possible process time per employee value;
f₁ is the fit of workspace features to work needs regression coefficient value;
f₂ is the comfort regression coefficient value;
f₃ is the support for communication regression coefficient value;
f₄ is the support for collaboration regression coefficient value;
f₅ is the job/environmental control regression coefficient value;
f₆ is the support for sense of community regression coefficient value;
IA₁ is the investment amount adjustment for the fit of workspace features to work needs workplace design feature;
IA₂ is the investment amount adjustment for the comfort workplace design feature;
IA₃ is the investment amount adjustment for the support for communication workplace design feature;
IA₄ is the investment amount adjustment for the support for collaboration workplace design feature;
IA₅ is the investment amount adjustment for the job/environment control workplace design feature;
IA₆ is the investment amount adjustment for the support for sense of community workplace design feature;
Cₚₜ is the overall average process cycle time per employee current performance estimate value; and,
IAₙ is a value between 0 and 10, inclusive.

Using the possible process time per employee value, the predicted business outcome module 214 calculates the additional predicted business outcome values in the process cycle time predicted business outcome category. The predicted business outcome module 214 determines the process cycle time saved value by subtracting the possible process time per employee value from the overall average process cycle time per employee current performance estimate value. The predicted business outcome module 214 also determines the current processes per employee year value by multiplying together the overall average process cycle time per employee current performance estimate value, the number of days per working year, and the number of working hours in a day. In addition, the predicted business outcome module 214 determines the possible processes per employee year value by multiplying together the possible process time per employee value, the number of days per working year, and the number of working hours in a day. The predicted business outcome module 214 further determines the increased processes per employee year value by subtracting the current processes per employee year value from the possible processes per employee year value. Moreover, the predicted business outcome module 214 determines the employee work hours saved per year value by multiplying together the total number of employees, the overall average process cycle time per employee current performance estimate value, and the increased processes per employee per year value. Finally, the predicted business outcome module 214 determines the estimated annual process cycle time savings value by finding the product of the employee work hours saved per year value and the average hourly cost per employee business specific data value.

Furthermore, the predicted business outcome module 214 may determine the possible retention rate value using regression coefficients from the retention row of Table 11. Equation 7 shows one equation for determining the possible retention rate value.

$${P}_{po / rr} = {\sum }_{n = 1}^{6} ( {g}_{n} \times {IA}_{n} ) + {C}_{po / rr} and \\ if ( {P}_{po / rr} < 0 ) then {P}_{po / rr} = 0 ; and , \\ If ( {P}_{po / rr} > {C}_{po / rr} + \frac{1 - {C}_{po / rr}}{2} ) then \\ {P}_{po / rr} = {C}_{po / rr} + \frac{1 - {C}_{po / rr}}{2} \qquad ( eq . 7 )$$

where:
P_{po/rr} is the possible retention rate value for the professional/office workplace environment type;
g₁ is the fit of workspace features to work needs regression coefficient value;
g₂ is the comfort regression coefficient value;
g₃ is the support for communication regression coefficient value;
g₄ is the support for collaboration regression coefficient value;
g₅ is the job/environmental control regression coefficient value;
g₆ is the support for sense of community regression coefficient value;
IA₁ is the investment amount adjustment for the fit of workspace features to work needs workplace design feature;
IA₂ is the investment amount adjustment for the comfort workplace design feature;
IA₃ is the investment amount adjustment for the support for communication workplace design feature;
IA₄ is the investment amount adjustment for the support for collaboration workplace design feature;
IA₅ is the investment amount adjustment for the job/environment control workplace design feature;
IA₆ is the investment amount adjustment for the support for sense of community workplace design feature;
C_{po/rr} is the annual retention rate current performance estimate value for the professional/office workplace environment type; and,
IAₙ is a value between 0 and 10, inclusive.

Using the possible retention rate value, the predicted business outcome module 214 calculates the additional predicted business outcome values in the retention rate predicted business outcome category. The predicted business outcome module 214 determines the possible annual replacement required value by subtracting the possible retention rate value from 100 and multiplying the result by the number of employees in the professional\office workplace environment. The predicted business outcome module 214 also determines a current annual replacement required value by subtracting the annual retention rate current performance estimate value from one and multiplying the result by the number of employees. In addition the predicted business outcome module 214 determines the possible annual hiring reduction value by subtracting the predicted possible annual replacement value from the current annual replacement required value. In one implementation, the possible annual hiring reduction value is negative. Furthermore, the predicted business outcome module 214 determines the annual cost to train new employee value by multiplying several values, including the average hourly cost per average employee, the number of hours in a typical working day, the number of days in a typical working year, and the average cost to hire and train new employee business specific data value. In one implementation, the predicted business outcome module 214 determines the estimated retention annual savings value by multiplying the annual cost to train new employee value by the possible annual hiring reduction value.

Additionally, the predicted business outcome module 214 may further determine the predicted claims cost per employee value using regression coefficients from the claim amount row shown in Table 11. Equation 8 shows one equation for calculating the predicted claims cost per employee value.

$${P}_{po / cc} = {\sum }_{n = 1}^{6} ( {h}_{n} \times {IA}_{n} ) + {C}_{po / cc} and \\ If ( {P}_{po / cc} < \frac{{C}_{po / cc}}{2} ) then {P}_{po / cc} = \frac{{C}_{po / cc}}{2} \qquad ( eq . 8 )$$

where:
P_{po/cc} is the predicted claims cost per employee value for the professional/office workplace environment type;
h₁ is the fit of workspace features to work needs regression coefficient value;
h₂ is the comfort regression coefficient value;
h₃ is the support for communication regression coefficient value;
h₄ is the support for collaboration regression coefficient value;
h₅ is the job/environmental control regression coefficient value;
h₆ is the support for sense of community regression coefficient value;
IA₁ is the investment amount adjustment for the fit of workspace features to work needs workplace design feature;
IA₂ is the investment amount adjustment for the comfort workplace design feature;
IA₃ is the investment amount adjustment for the support for communication workplace design feature;
IA₄ is the investment amount adjustment for the support for collaboration workplace design feature;
IA₅ is the investment amount adjustment for the job/environment control workplace design feature;
IA₆ is the investment amount adjustment for the support for sense of community workplace design feature;
C_{po/cc} is the current claims cost per agent value; and,
IAₙ is a value between 0 and 10, inclusive.

Using the predicted claims cost per employee value, the predicted business outcome module 214 calculates additional predicted business outcome values in the health and safety claims cost predicted business outcome category. For example, the predicted business outcome module 214 determines the estimated annual health and safety claims savings value by subtracting the predicted claims cost per employee value from the estimated annual claim amount per employee current performance estimate value.

In one embodiment, the predicted business outcome module 214 communicates with the reporting module 216 to output the predicted business outcome values of the selected professional\office project type to the output device 114. Examples of outputting the predicted business outcome values include displaying the predicted business outcome values on a display device or by writing the predicted business outcome values to a file as a part of a storage device. Alternatively, or in addition to communicating the predicted business outcome values to the reporting module 216, the predicted business outcome module 214 216 may store one or more predicted business outcome values in the predicted business outcome data table 224. The predicted business outcome values may be later retrieved from the predicted business outcome data table 224 using an associated customer identifier.

Like the workplace design feature investment amounts of the selected call center project type, the optimization module 212 is also operative to adjust one or more workplace design feature investment amounts for the selected professional\office type according to the optimization of a predicted business outcome. In particular, the optimization module 212 is operative to minimize the possible rework value, to minimize the possible process time value, to maximize the possible retention rate value, and to minimize the predicted claims cost per employee value. The optimization module 212 may further communicate with the reporting module 216 to display charts or graphs that illustrate effect of optimizing a predicted business outcome value.

Optimizing a predicted business outcome value may affect the investment amount in one or more workplace design features for the selected professional\office project type. Table 12 shows the affects on the workplace design feature investment amounts when an associated predicted business outcome value is optimized.

TABLE 12

| Optimization/ | | | | |
|---|---|---|---|---|
| Workplace Design | | | Maximize Possible | Minimize Predicted |
| Feature Investment | Minimize Possible | Minimize Possible | Retention Rate | Claims Cost Per |
| Amount Adjustment | Rework Value | Process Time Value | Value | Employee Value |
| Fit of Workspace | 0% | 40% | 0% | 40% |
| Features to Work | | | | |
| Needs | | | | |
| Comfort | 0% | 0% | 0% | 40% |
| Support for | 0% | 40% | 40% | 40% |
| Communication | | | | |
| Support for | 0% | 40% | 0% | 0% |
| Collaboration | | | | |
| Job/Environmental | 40% | 0% | 40% | 40% |
| Control | | | | |
| Support for Sense | 0% | 0% | 40% | 0% |
| of Community | | | | |

The EP-ROI tool 102 also includes multiple interfaces for interacting with each of the modules 202-216. The interfaces for the modules 202-216 may depend on the selected workplace environment type, the selected project type, or combinations thereof.

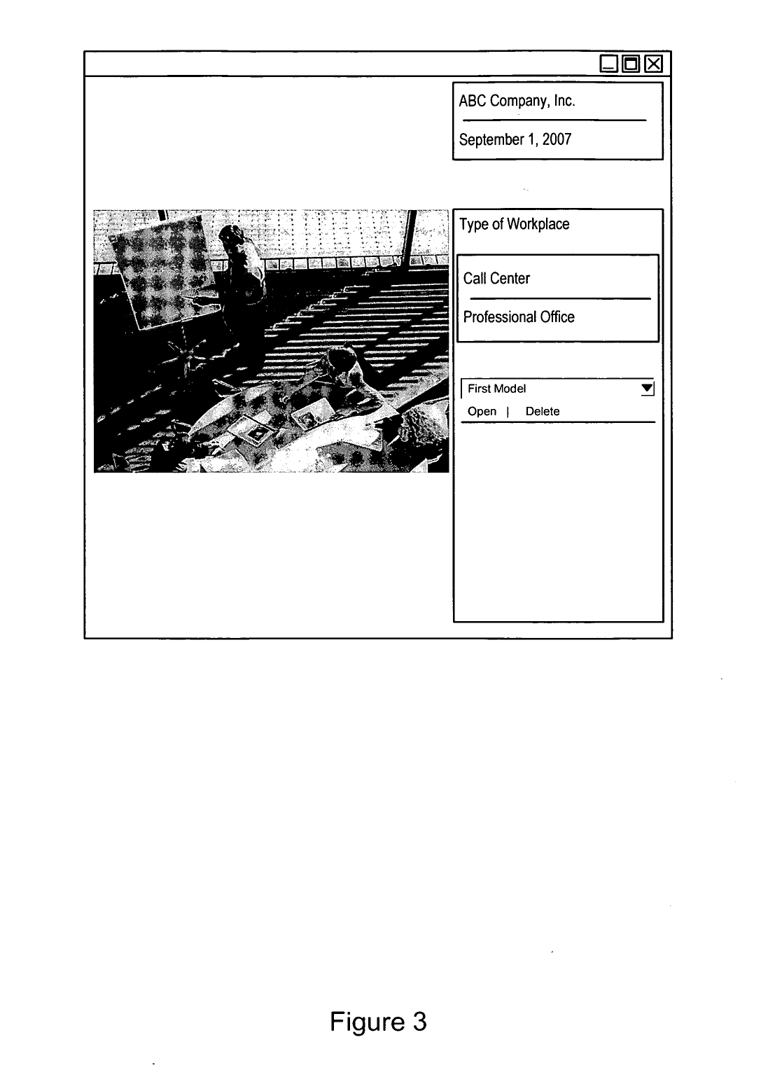

Turning first to FIG. 3 is an exemplary interface for interacting with the workplace environment type selection module 202. Using the interface shown in FIG. 3, a workplace environment type may be selected, a customer account identifier may be created and associated with a new customer model, a previous customer model may be retrieved using a previously created customer account identifier, and a previously created customer model may be deleted for an associated customer account identifier. In one implementation, workplace environment types include a call center workplace environment and a professional/office workplace environment. However, additional workplace environment types may be implemented.

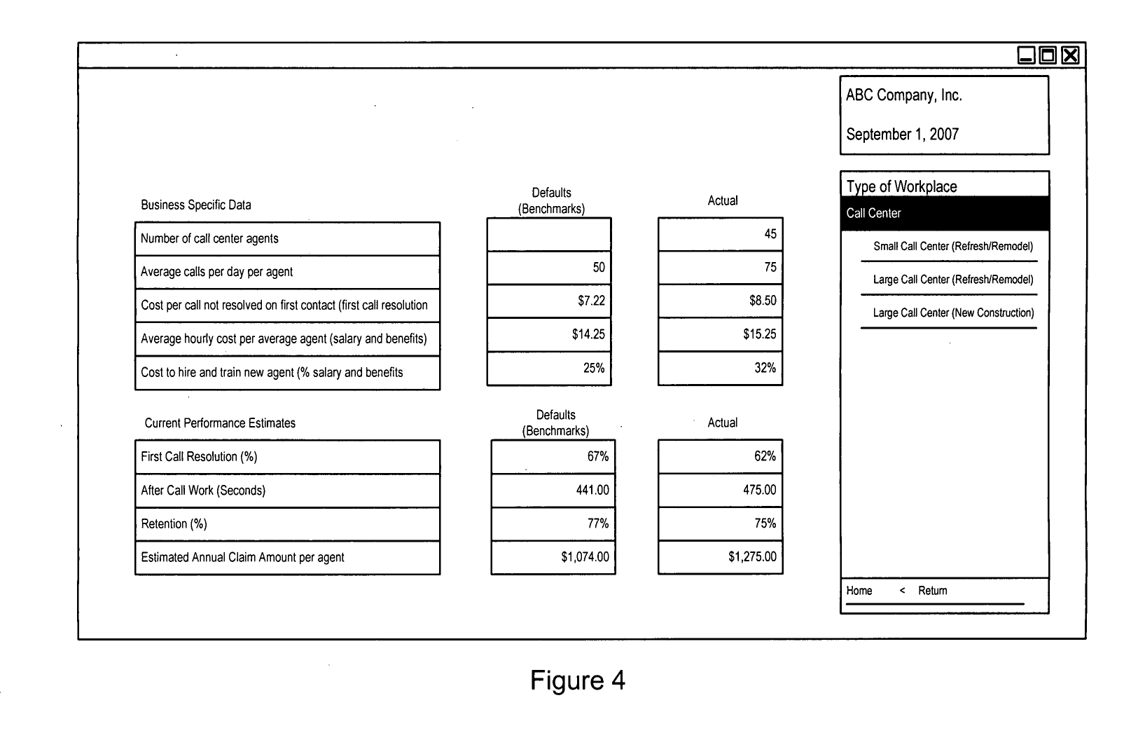

FIG. 4 shows an exemplary interface for interacting with the business data module 204 when a call center workplace environment type is selected. The interface shown in FIG. 4 includes multiple fields for entering one or more business specific data values, such as the number of call center agents, and includes multiple fields for entering one or more current performance estimate values. FIG. 4 further shows an exemplary interface for interacting with the project type selection module 206. In one implementation, the interface for interacting with the project type selection module 206 includes the option of selecting a small call center project type, a large call center project type, and a large call center project type when new construction is involved.

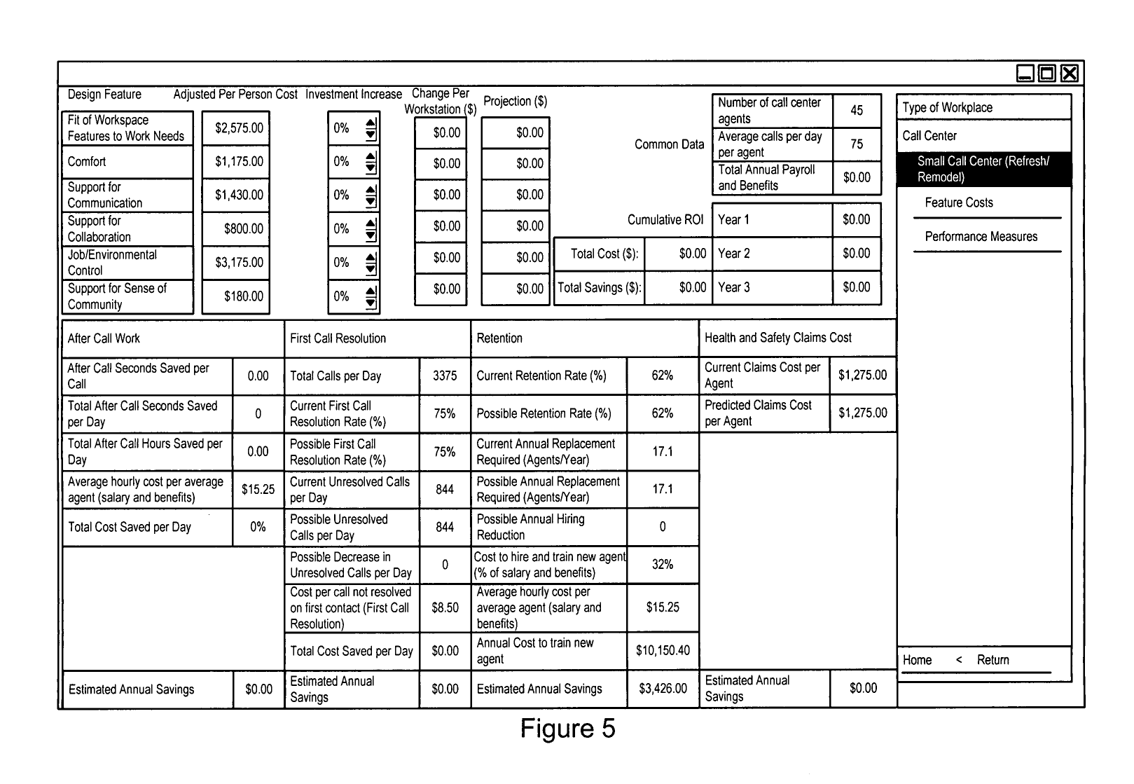

FIG. 5 shows an exemplary interface for interacting with the workplace design feature investment amount module 208 and the predicted business outcome module 214. Using the interface shown in FIG. 5, one or more workplace design feature investment amounts may be adjusted according to a investment amount adjustment. The interface of FIG. 5 further shows the predicted business outcome values determined by the predicted business outcome module 214.

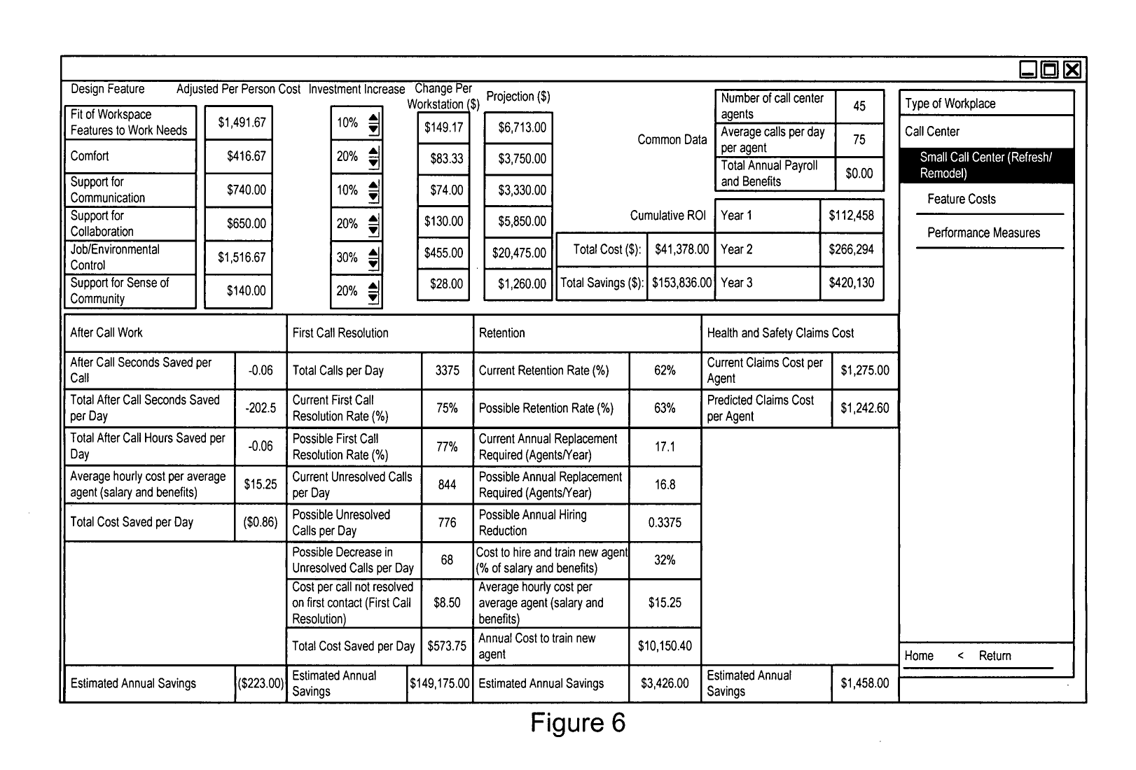

FIG. 6 shows the exemplary interface of FIG. 5 when the workplace design feature investment amounts are adjusted. As one example of an investment amount adjustment, the workplace design feature investment amount for the support for collaboration workplace design feature has been increased by 20%. Furthermore, as each of the workplace design feature investment amounts have been adjusted, the workplace component cost module 210 and the predicted business outcome module 214 have made corresponding determinations and calculations for the workplace component costs and the predicted business outcome values, respectively.

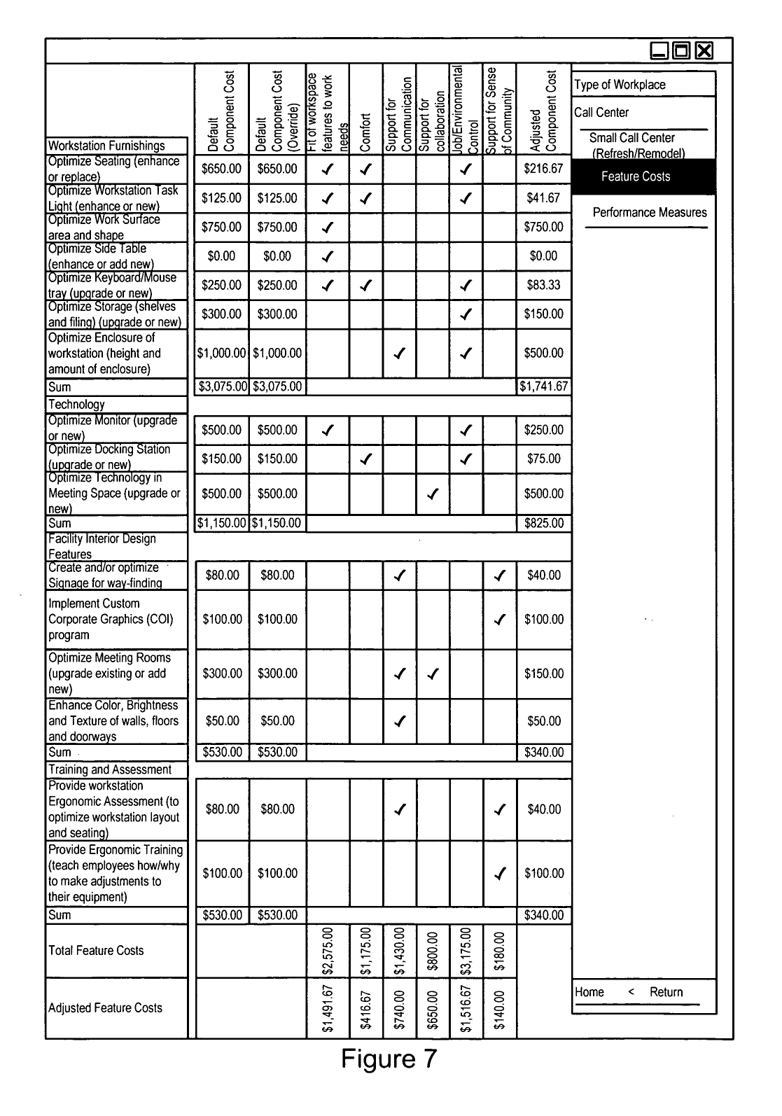

FIG. 7 shows an exemplary interface for interacting with the workplace component cost module 210. Using the interface shown in FIG. 7, one or more workplace components may be adjusted, such as by increasing or decreasing the cost associated with the workplace component. The interface of FIG. 7 further shows the association between the multiple workplace design features and the multiple workplace components. Also shown are initial and adjusted workplace design feature investment amounts as summations of corresponding workplace component costs.

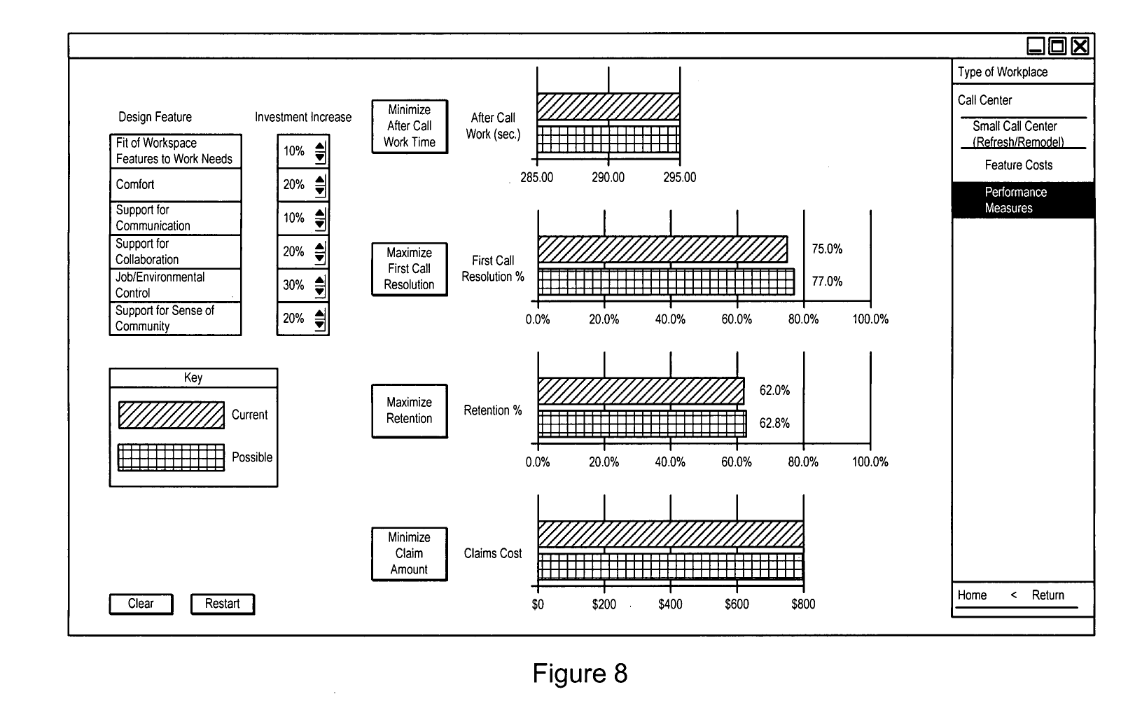

FIG. 8 shows an exemplary interface for interacting with the optimization module 212. In the embodiment shown in FIG. 8, the interface for the optimization module 212 includes multiple selectable input options for optimizing multiple predicted business outcomes associated with the small call center project type. The interface also includes multiple graphs prepared by the reporting module 216 for graphically showing the effects of optimizing associated predicted business outcome values. In FIG. 8, the optimization module 212 has not optimized any of the predicted business outcome values.

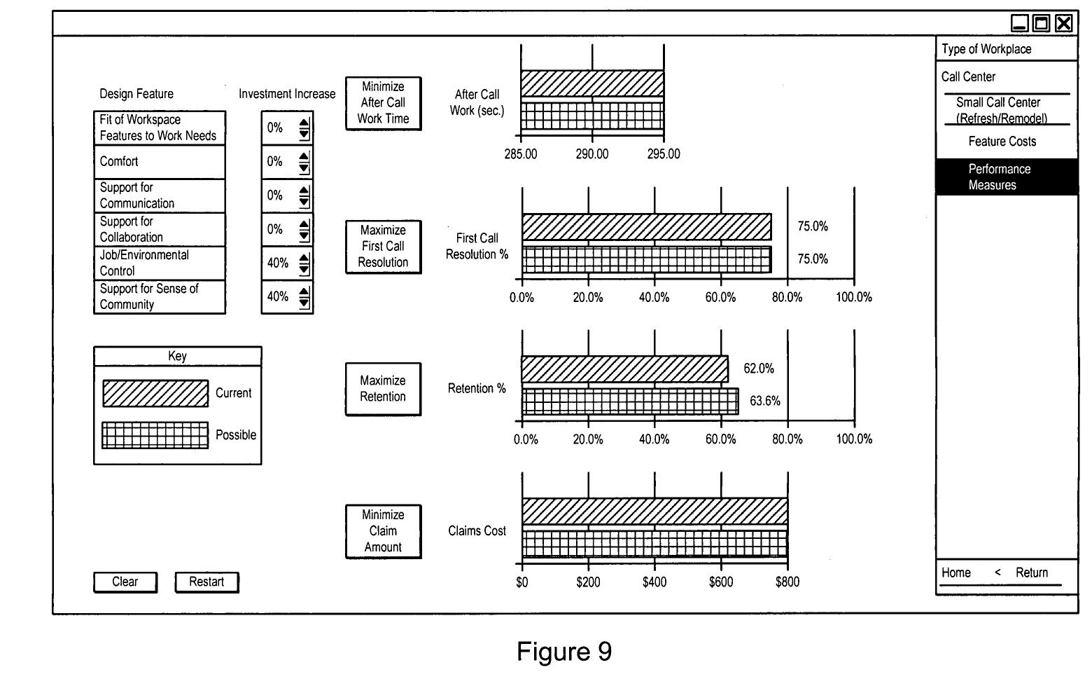

FIG. 9 shows the exemplary interface of FIG. 8 when the possible retention rate predicted business outcome value is optimized for the small call center project type. The interface of FIG. 9 further shows that corresponding adjustments have been made in the job/environmental control workplace design feature investment amount and the support for sense of community workplace design feature investment amount. Additionally, the interface of FIG. 9 shows with an associated graph the effect of optimizing the possible retention rate value.

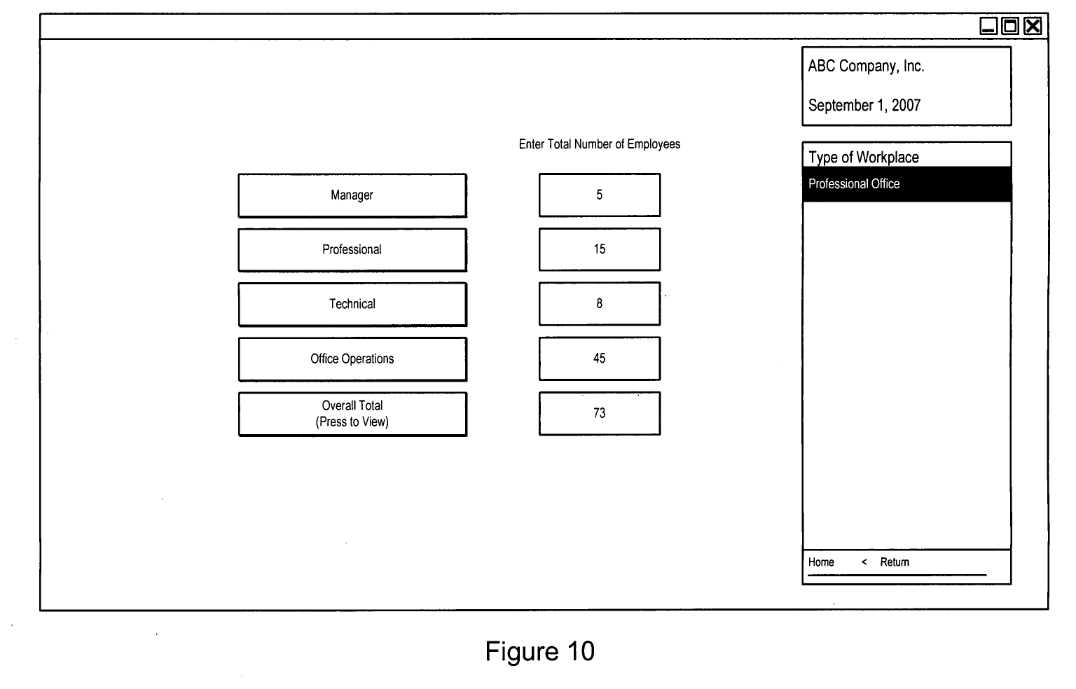

Turning now to FIG. 10 is an additional exemplary interface for interacting with the business data module 204 when the professional\office workplace environment type is received by the workplace environment type selection module 202. The interface in FIG. 10 includes multiple data fields for entering information for the previously discussed employee types associated with the professional\office workplace environment type. In one implementation, each of the employee types may have their own associated business specific data values and current performance estimate values. Although four employee types are shown in the interface of FIG. 10, additional or fewer employee types may be implemented.

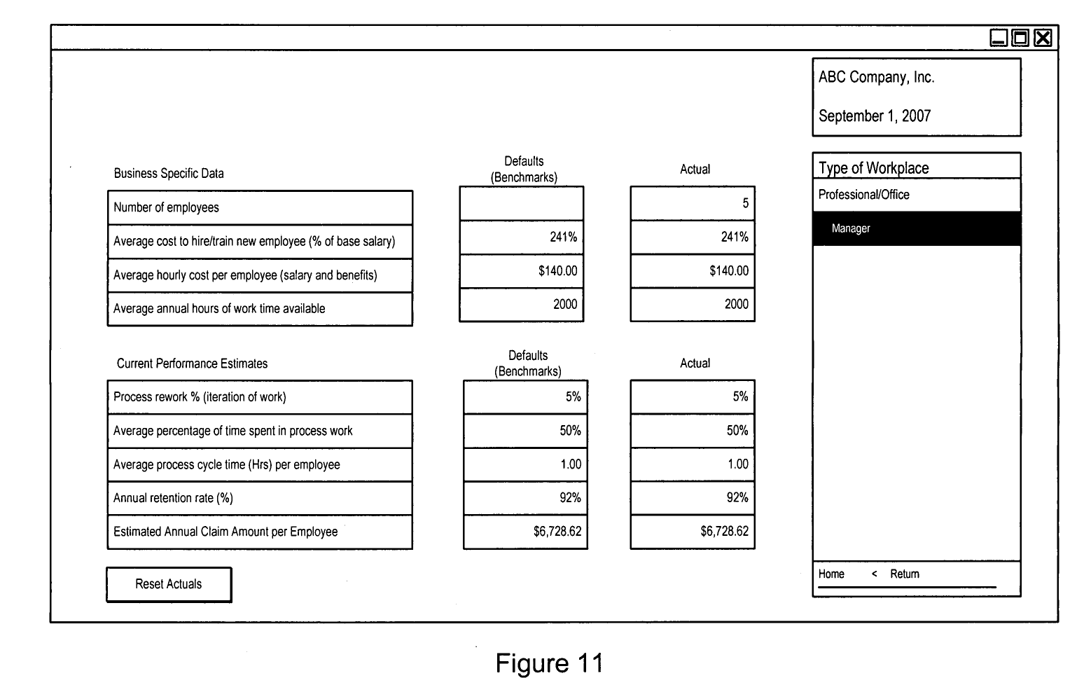

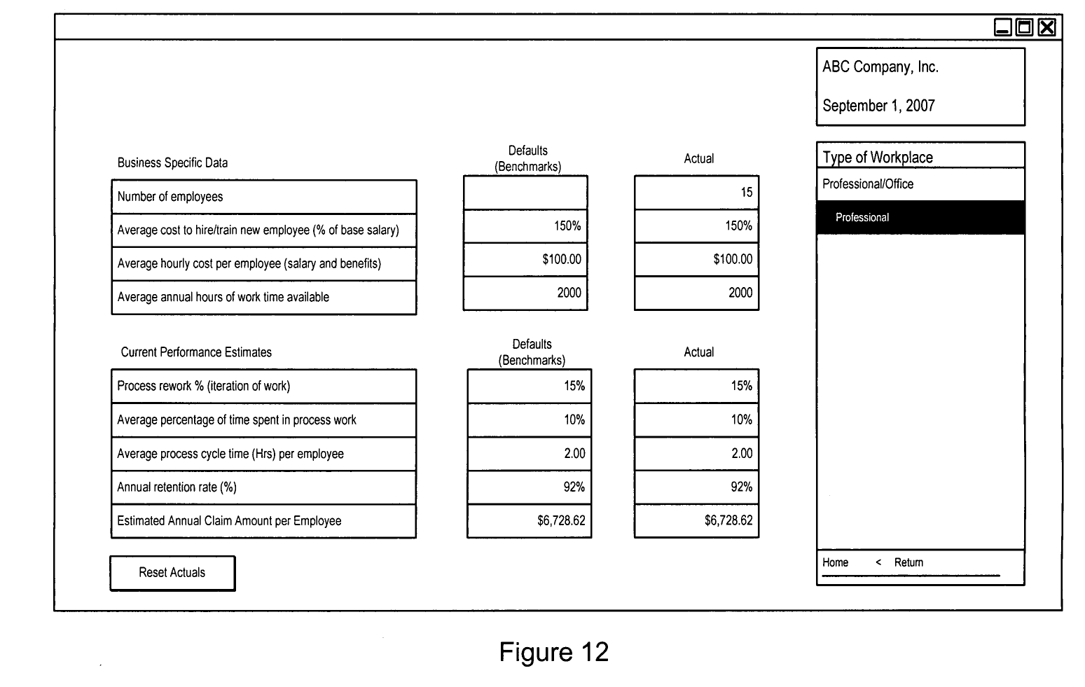

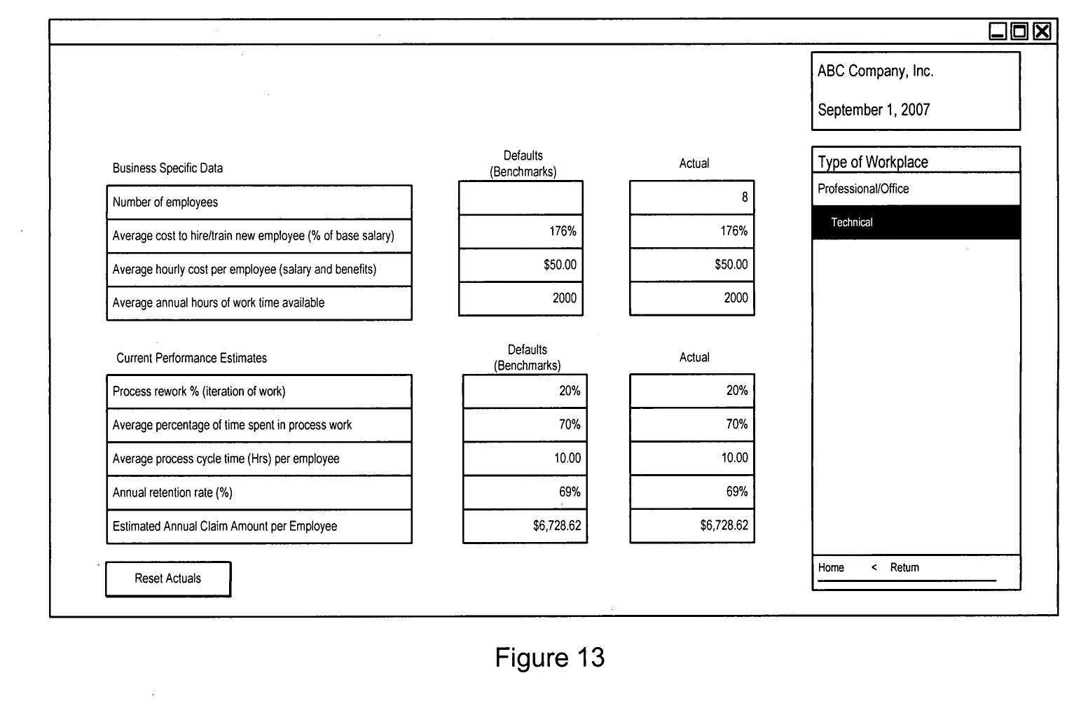

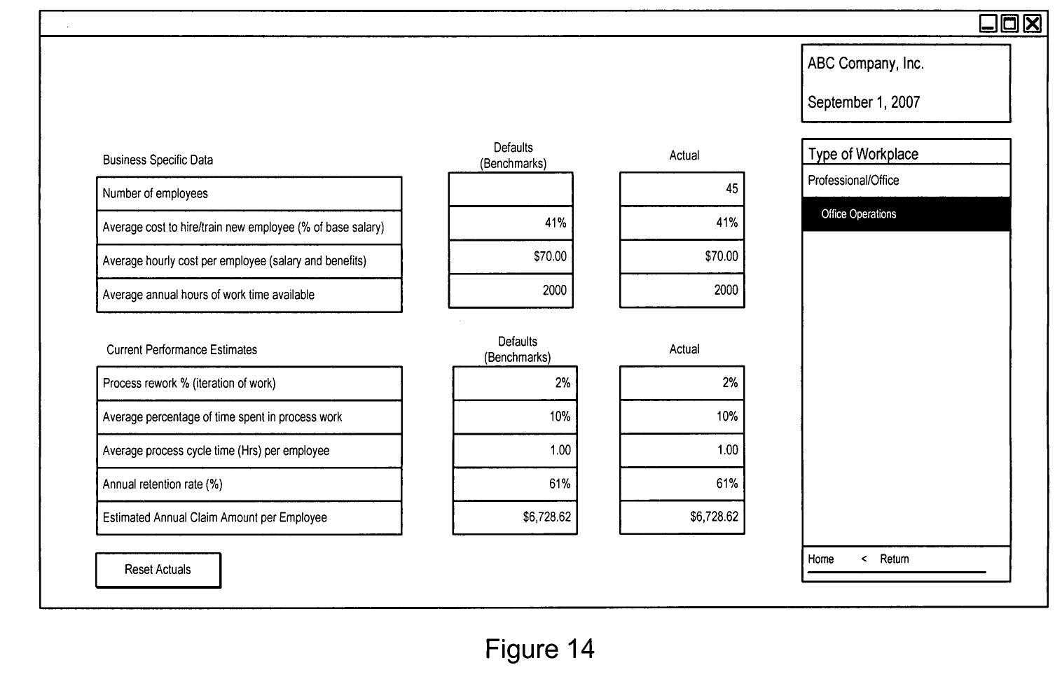

FIG. 11 shows an exemplary interface for providing business specific data values and current performance estimate values for a manager type employee selected using the interface of FIG. 10. Similarly, FIG. 12 shows an exemplary interface for providing business specific data values and current performance estimate values for a professional type employee when the professional type employee is selected using the interface of FIG. 10. Additionally, FIG. 13 shows an exemplary interface for providing business specific data values and current performance estimate values for a technical type employee previously selected using the interface of FIG. 10. Finally, FIG. 14 shows an exemplary interface for providing business specific data values and current performance estimate values for an office operations type employee selected using the interface of FIG. 10. The EP-ROI tool 102 may implement additional or fewer interfaces for the different employee types.

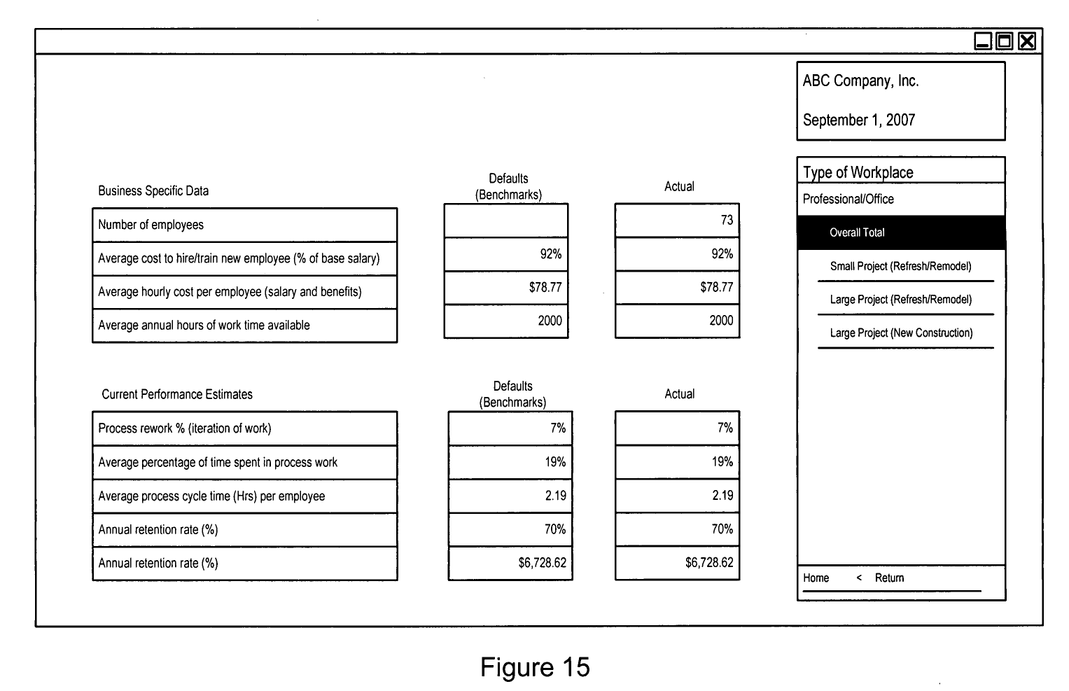

In addition to implementing multiple interfaces for the modules 202-216 when a call center workplace environment type is selected, the EP-ROI tool 102 may also implement multiple interfaces for the modules 202-216 when a professional\office workplace environment type is selected. For example, FIG. 15 shows an exemplary interface for interacting with the project type selection module 206 when a professional\office workplace environment type is selected. As shown in FIG. 15, the selectable projects for a professional\office workplace environment type include a small professional\office project type, a large professional\office project type, and a large professional\office project type for new construction. The interface of FIG. 15 further shows the overall business specific data values and the overall current performance estimate values determined by the business data module 204 using the business specific data values and the current performance estimate values from the configured employee types.

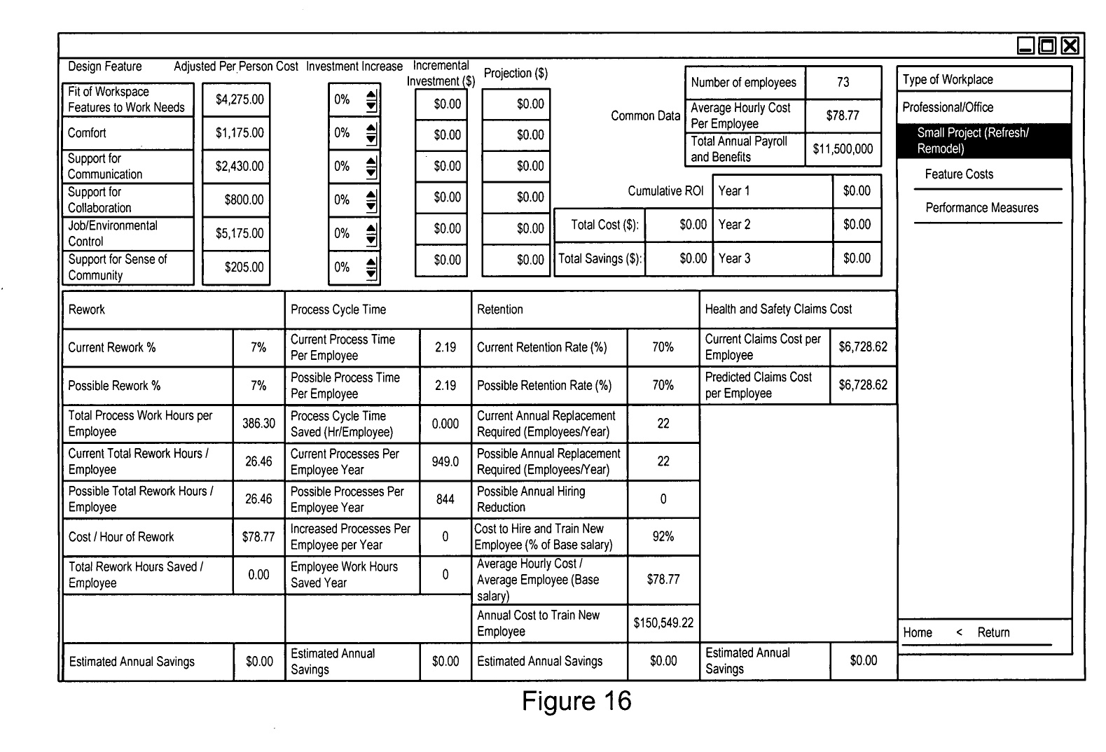

FIG. 16 shows an exemplary interface for interacting with the workplace design feature investment amount module 208 and the predicted business outcome module 214 when a selection of the small professional\office project type is received by the workplace design feature investment amount module 208. Using the interface shown in FIG. 16, one or more workplace design feature investment amounts may be adjusted according to an investment amount adjustment. The interface of FIG. 16 further shows the predicted business outcome values determined by the predicted business outcome module 214.

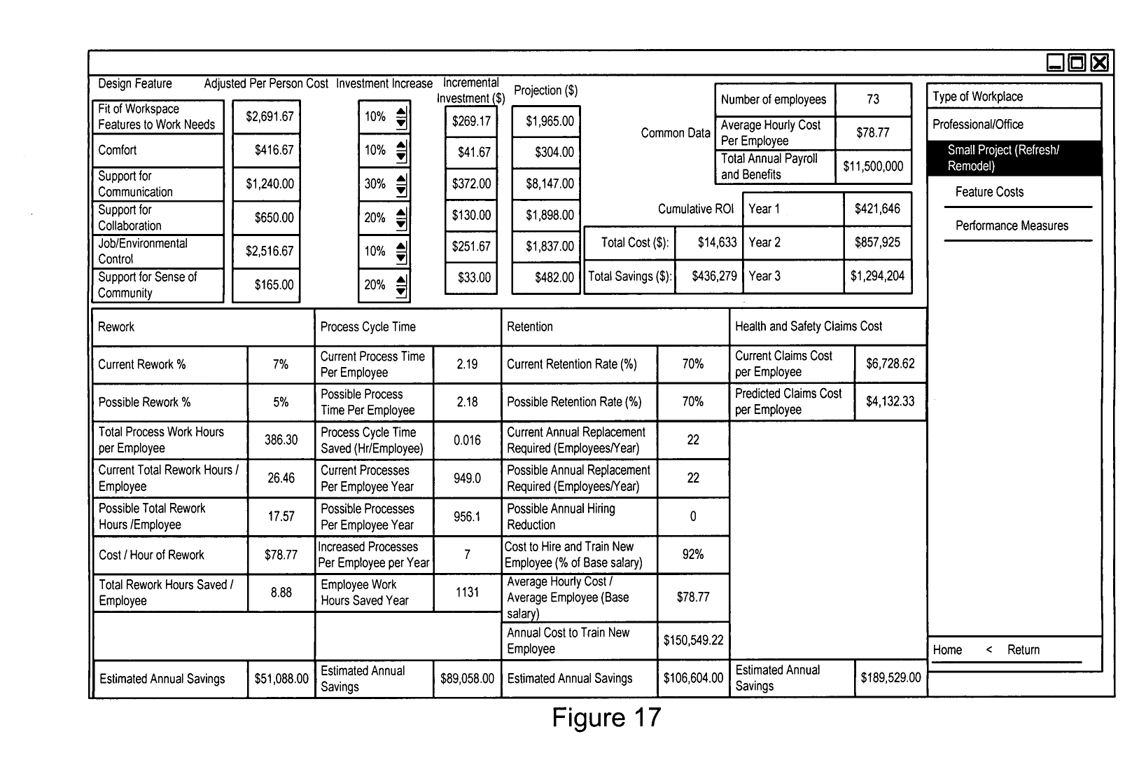

FIG. 17 shows the exemplary interface of FIG. 16 when the workplace design feature investment amounts are adjusted. As one example of an investment amount adjustment, the workplace design feature investment amount for the support for collaboration workplace design feature has been increased by 20%. Furthermore, as each of the workplace design feature investment amounts have been adjusted, the workplace component cost module 210 and the predicted business outcome module 214 have made corresponding determinations and calculations for the workplace component costs and the predicted business outcome values, respectively.

As previously discussed, the EP-ROIL tool 102 may implement different interfaces for the modules 202-216 depending on the selected workplace environment type or the selected project type. However, the EP-ROI tool 102 may implement similar interfaces for the modules 202-216 when different workplace environment types or different project types are selected. In one embodiment, the interface for interacting with the component cost module 210 when the call center workplace environment type is selected may be similar to the interface for interacting with the component cost module 210 when the professional\office workplace environment type is selected. In this embodiment, the component cost module 210 retrieves initial component costs from the component costs table 222 corresponding to the project type previously received by the workplace design feature investment amount module 206.

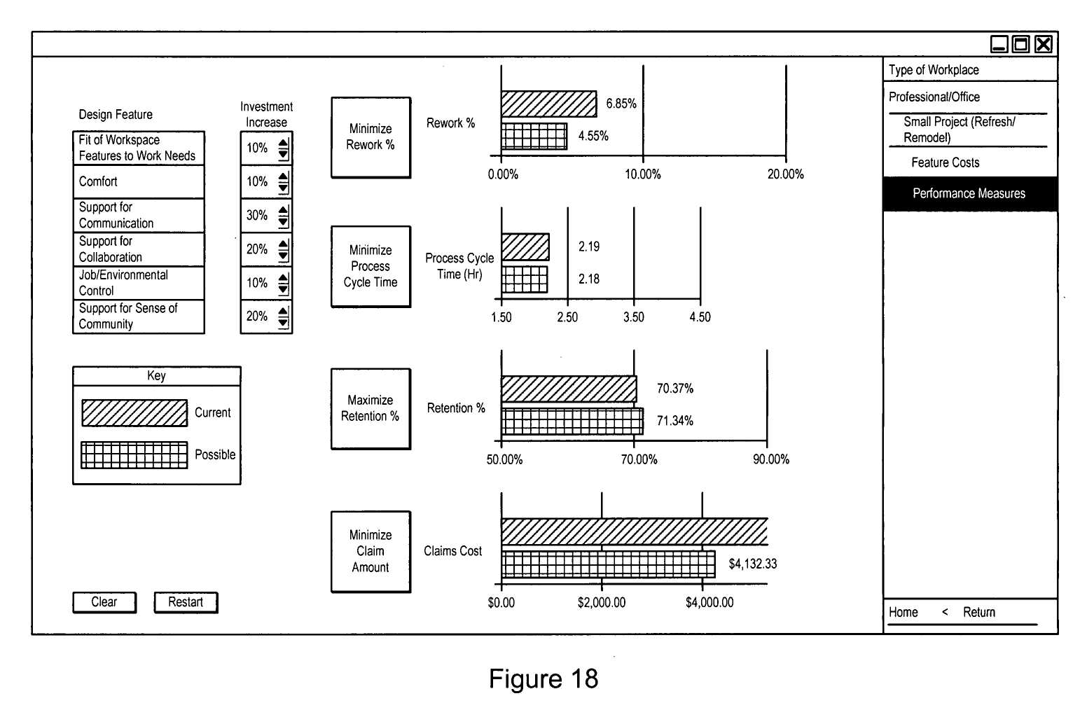

FIG. 18 shows an exemplary interface for interacting with the optimization module 212 when the small professional\office project type is received by the workplace design feature investment amount module 208. In the embodiment shown in FIG. 18, the interface for the optimization module 212 includes multiple selectable input options for optimizing multiple predicted business outcome values associated with the professional\office workplace environment type. The interface also includes multiple graphs prepared by the reporting module 216 for graphically showing the effects of optimizing the predicted business outcome values. In FIG. 18, the optimization module 212 has not optimized any of the predicted business outcome values.

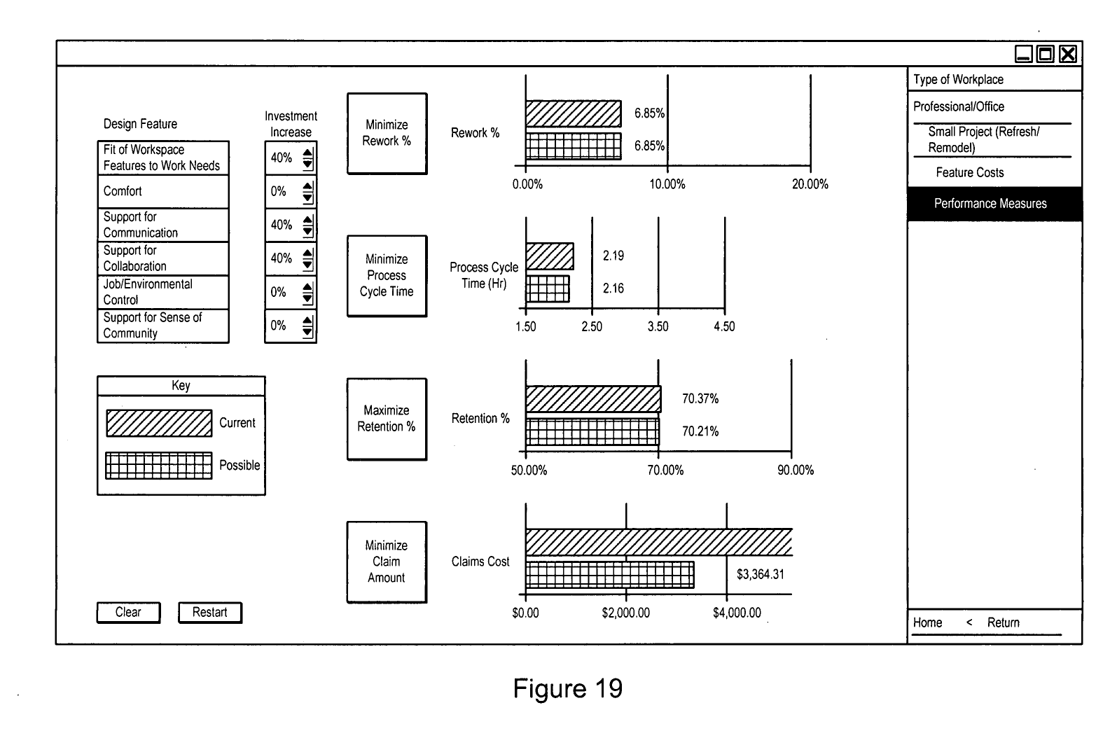

FIG. 19 shows the exemplary interface of FIG. 18 when the possible process time value is optimized for the small professional\office project type. The interface of FIG. 19 further shows that corresponding adjustments have been made in the fit of workspace features to work needs design feature investment amount, the support for communication workplace design feature investment amount, and the support for collaboration workplace design feature investment amount. Additionally, the interface of FIG. 19 shows with an associated graph the effect of optimizing the possible process time value.

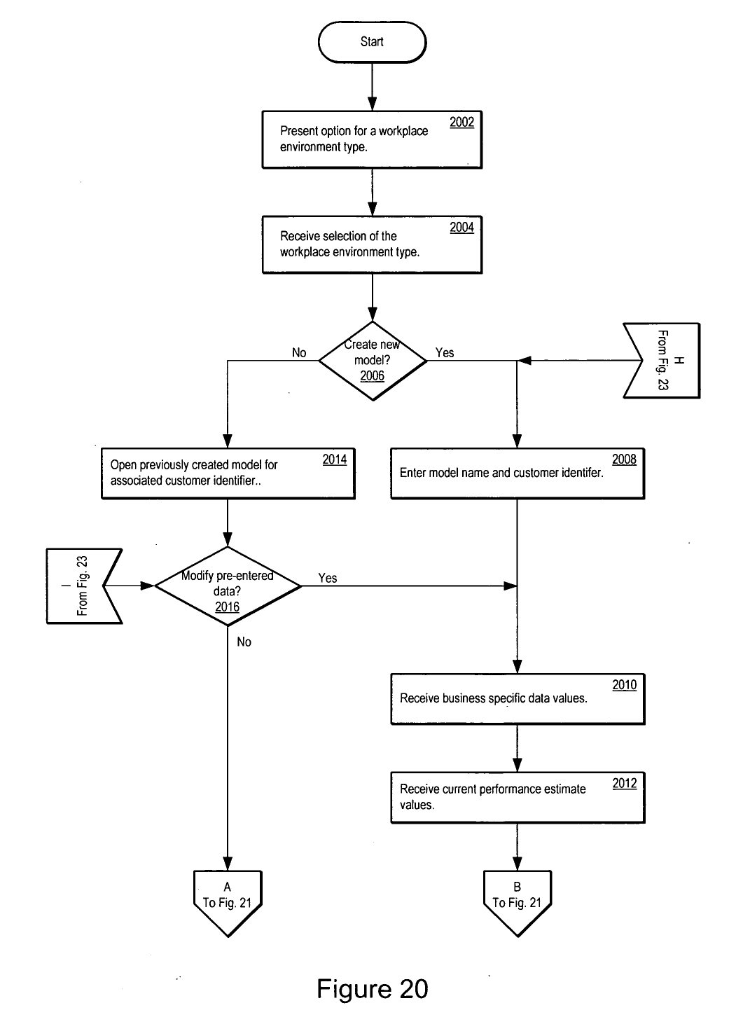

With reference to FIG. 1 and FIG. 2, FIGS. 20-23 show flow diagrams for determining predicted business outcome values using workplace design feature investment amounts. Beginning with FIG. 20, the workplace environment type selection module 202 first presents options for selecting a workplace environment type (2002). For example, the options may be output to the output device 114. The workplace environment type selection module 202 then receives a selected workplace environment type (2004). A selection is then received as to whether a new customer model should be created (2006). In one embodiment, the selection as to whether a new customer model should be created is received from the input device 104. Where the selection indicates the creation of a new customer model, the workplace environment type selection module 202 receives a customer model name and an associated customer identifier (2008). The workplace environment type selection module 202 then communicates the selected workplace environment type to the business data module 204.

The business data module 204 receives the business specific data values for the corresponding selected workplace environment type (2010). The business data module 204 also receives the current performance estimate values for the corresponding selected workplace environment type (2012). In one embodiment, the business data module 204 receives the business specific data values and the current performance estimate values from the input device 104.

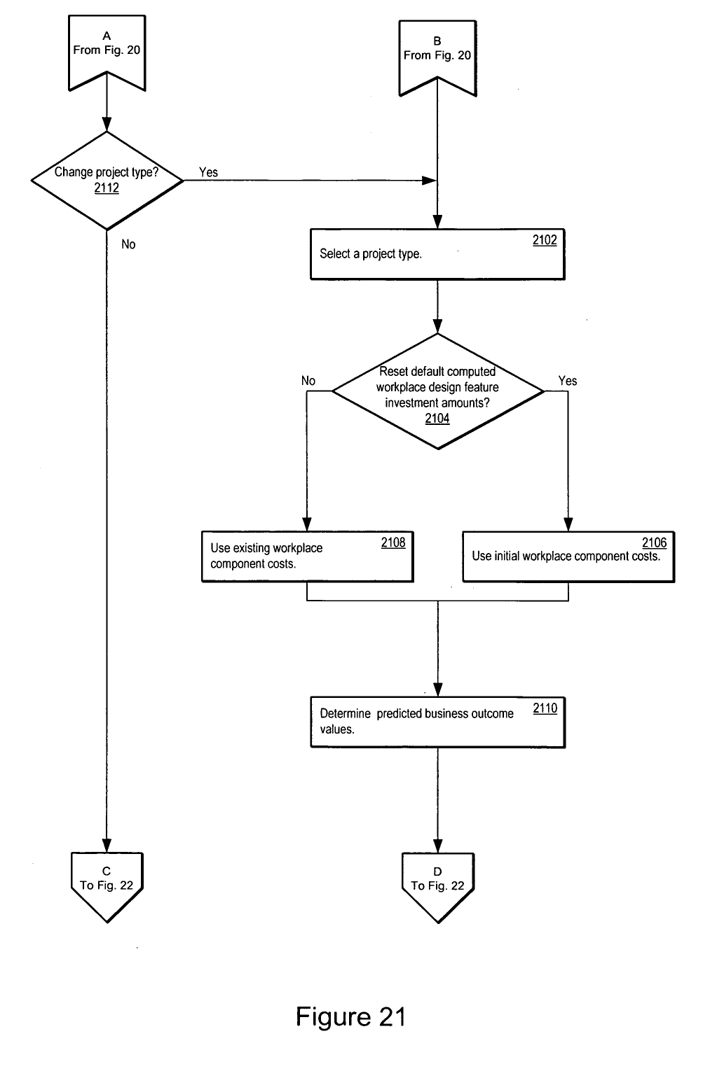

Alternatively, a selection may have been received that indicates the workplace environment type selection module 202 should retrieve a previously created customer model from the customer models table 220. In this scenario, the workplace environment type selection module 202 retrieves the previously created customer model using an associated customer identifier (2014). A selection is then received as to whether the data of the previous customer model should be modified or adjusted (2016). In one embodiment, the workplace environment type selection module 202 receives the selection as to whether the data of the previous customer model should be modified or adjusted from the input device 104. If the selection indicates that the data for the previous customer model should be modified, then the workplace environment type selection module 202 communicates with the business data model 204 to receive additional or replacement business specific data values (2010) and current performance estimate values (2012). If the selection indicates that the data for the previous customer model should not be modified, then the workplace environment type selection module 202 continues the processing flow onto the project type selection module 206 as shown in FIG. 21.

Referring now to FIG. 21 with continued reference to FIG. 1 and FIG. 2, where the business data module 204 finishes receiving business specific data values (201) and current performance estimate values (2012), the project type selection module 206 presents an option for selection a project type (2102). In one embodiment, the project type selection module 206 receives selected project type from the input device 104. The project type selection module 206 then communicates the selected project type to the workplace component cost module 210. The workplace component cost module 210 may then present an option to use previous component costs from a previous customer model, or to reset the component costs in the case of a new customer model (2104). In one embodiment, a new customer model created during the same session as a previously created customer model may use the component costs for the previously created customer model.

The workplace component cost module 210 then receives an option to either use the existing component cost costs or to use the initial workplace component costs associated with the selected project type. For example, the workplace component cost module 210 may receive the option from the input device 104. Depending on the option received, the workplace component cost module 210 then either uses the existing workplace component costs (2108) or uses the initial component costs for the associated selected project type (2106). The workplace component cost module 210 may retrieve the existing workplace component costs and the initial component costs from the component costs table 222. Thereafter, the workplace component cost module 210 communicates with the workplace design feature investment amount module 208 to determine initial workplace design feature investment amounts. The workplace design feature investment amounts are then used by the predicted business outcome module 214 to determine predicted business outcome values for the selected project type (2110).

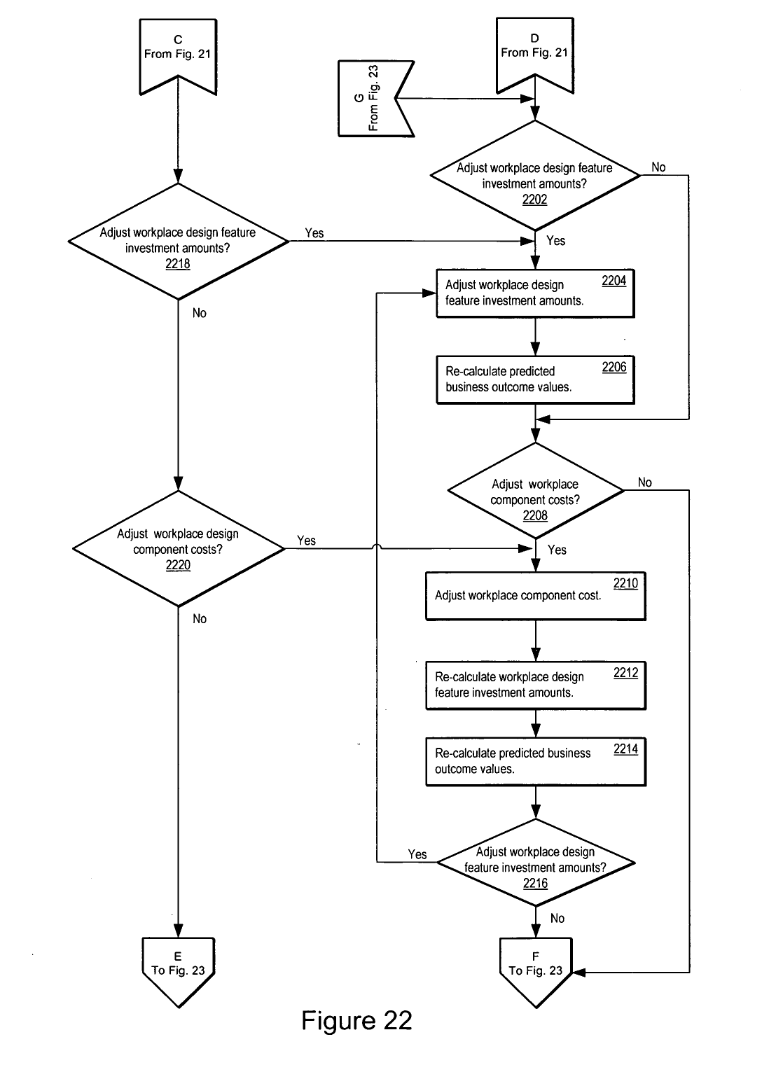

Alternatively, the process flow may proceed from a decision not to adjust the data values for a previously created customer model. In this instance, the project type selection module 206 receives a selection indicating whether to change the project type associated with the previously created customer model (2112). Where the project type selection module 206 receives a selection indicating changing the project type of the previously created customer model, the process flow proceeds to the selection of a project type (2102). However, where a decision is made not to change the project type, the process flow continues on to FIG. 22.

With reference to FIG. 22 and returning to the process flow where the predicted business outcome module 214 determined predicted business outcome values (2110), the workplace design feature investment amount module 208 receives an indication whether to adjust one or more workplace design feature investment amounts (2202). Where the workplace design feature investment amount module 208 receives an indication to adjust one or more design feature investment amounts, then the workplace design feature investment amount module 208 adjusts the corresponding workplace design feature investment amounts (2204). In addition, the predicted business outcome values are then re-calculated using the adjusted workplace design feature investment amounts (2206).

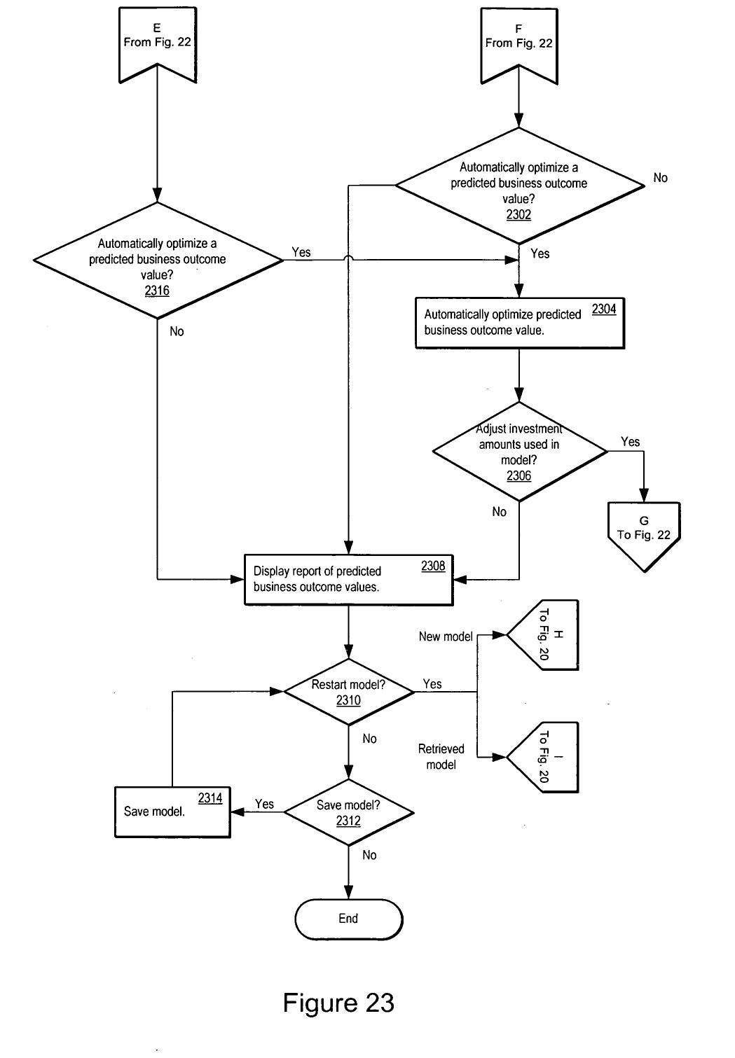

After adjusting the workplace design feature investment amounts, the workplace design feature investment amount module 208 communicates which workplace design features were adjusted to the workplace component cost module 210. The component cost module 210 then determines whether to adjust associated component costs based on which workplace design features were adjusted (2208). Where the component cost module 210 determines not to adjust associated component costs, the processing flow continues on to the optimization module 212 as shown in FIG. 23.

Alternatively, the workplace component cost module 210 determines to adjust one or more associated component costs and proceeds to adjust the associated component costs (2210). The workplace component cost module 210 may then re-calculate workplace design feature investment amounts corresponding to the change in the workplace component costs (2212). The workplace component cost module 210 then communicates the re-calculated workplace design feature investment amounts to the predicted business outcome module 214, which then re-calculates corresponding predicted business outcome values (2214). The workplace design feature investment amount module 208 may then receive an additional indication, such as from the input device 104, to adjust one or more re-calculated workplace design feature investment amounts (2216). Where the workplace design feature investment amount module 208 receives an indication to adjust one or more re-calculated workplace design feature investment amounts, the workplace design feature investment amount module 208 returns to adjusting the corresponding workplace design feature investment amounts (2204). Alternatively, the workplace design feature investment amount module 208 may not adjust a re-calculated workplace design feature investment amount, in which case, the processing flow continues on to the optimization module 212 as shown in FIG. 23.

With continued reference to FIG. 23, and returning to the scenario where a previously created customer model was retrieved and a decision was made not to change the associated project type, the process flow proceeds to the workplace design feature investment amount module 208. The workplace design feature investment amount module 208 then receives an indication whether to adjust a workplace design feature investment amount (2218). If the workplace design feature investment amount module 208 receives an indication to adjust a workplace design feature investment amount, then the workplace design feature investment amount module 208 adjusts the indicated workplace design feature investment amount (2204).

However, the workplace design feature investment amount module 208 may receive an indication not to adjust a workplace design feature investment amount. In this scenario, the workplace component cost module 210 then receives an indication whether to adjust a component cost (2220). Where the workplace component cost module 210 receives an indication to adjust a component cost, the workplace component cost module 210 proceeds to adjust the associated component cost Alternatively, the workplace component cost module 210 may receive an indication not to adjust a workplace component cost, in which case, processing flow continues onto the optimization module 212 as shown in FIG. 23.

As shown in FIG. 23, the optimization module 212 receives an indication whether to optimize a predicted business outcome value. The optimization module 212 may receive the indication whether to optimize a predicted business outcome for a new customer model (2302) or a previously created customer model (2316). Where the optimization module 212 receives an indication to optimize a predicted business outcome value, the optimization module 212 automatically optimizes the predicted business outcome value (2304). As previously discussed, optimizing a predicted business outcome value affects one or more corresponding workplace design feature investment amounts. Accordingly, the optimization module 212 then communicates the affected workplace design feature investment amounts to the workplace design feature investment amount module 208. The workplace design feature investment amount module 208 then receives an indication whether to further adjust the workplace design feature investment amounts (2306). Where the workplace design feature investment amount module 208 receives an indication to further adjust the workplace design feature investment amounts, the processing flow returns, as indicated, to FIG. 22. Alternatively, the processing flow proceeds to reporting the various predicted business outcome values (2308).

However, the optimization module 212 may receive an indication not to optimize a predicted business outcome value. Where the optimization module 212 receives an indication not to optimize a predicted business outcome value, the processing flow also proceeds to reporting the various predicted business outcome values (2308). In one embodiment, the reporting module 216 reports the various predicted business outcome values.

After reporting the predicted business outcome values, the EP-ROI tool 102 then receives an indication whether to restart the current model (2310). Where the EP-ROI tool 102 receives an indication to restart the current model, the processing flow returns to the workplace environment type selection module 202 as shown in FIG. 20. As shown in FIG. 23, the entry point into the workplace environment type selection module 202 is dependent on whether the current model was a previously retrieved model or a newly created model.

Alternatively, the EP-ROI tool 102 receives an indication not to restart the current model, in which case, the EP-ROI tool 102 receives an indication whether to save and store the current model (2312). Where the EP-ROI tool 102 receives an indication to save and store the current model (2312), one or more modules 202-216 communicate with the database 118 to store the current customer model associated with the customer identifier (2314). For example, the modules 202-216 may communicate with the customer models table 220 to store the business specific data values, the current performance estimate values, the workplace design feature investment amounts, and the calculated predicted business outcome values for later retrieval using the associated customer model identifier. Alternatively, the EP-ROI tool 102 may receive an indication not to save and store the current customer model.

After performing the various determinations in reaching the predicted business outcome values, the EP-ROI tool 102 then terminates.

While various embodiments of the innovation have been described, it will be apparent to those of ordinary skill in the art that many more embodiments and implementations are possible within the scope of the innovation. Accordingly, the innovation is not to be restricted except in light of the attached claims and their equivalents.

We claim:

1. A method for predicting a predicted business outcome value using workplace design feature investment amounts comprising:
receiving a selection of a workplace environment type;
receiving a business specific data value corresponding to the workplace environment type;
receiving a current performance estimate values corresponding to the workplace environment type;
receiving a selection of a project type, where the project type corresponds to the selected workplace environment type;
calculating a plurality of workplace design feature investment amounts for a plurality of workplace design features, where each of the workplace design feature investment amounts correspond to a workplace design feature;
calculating a predicted business outcome value using the received workplace design feature investment amounts and the selected project type; and,
outputting the calculated predicted business outcome value.

2. The method of claim 1, further comprising:
adjusting a workplace design feature investment amount according to an investment amount adjustment;
calculating an adjusted workplace design feature investment amount using the workplace design feature investment amount and the investment amount adjustment; and,
re-calculating the previously calculated predicted business outcome value using the calculated adjusted workplace design feature investment amount.

3. The method of claim 1, further comprising calculating at least one workplace design feature investment amount using at least one workplace component cost amount.

4. The method of claim 3, where the at least one workplace component cost amount is a plurality of workplace component cost amounts.

5. The method of claim 4, where the workplace component cost amounts comprise at least one workplace component cost amount categorizable as a furnishing workplace component cost amount.

6. The method of claim 4, where the workplace component cost amounts comprise at least one workplace component cost amount categorizable as a technology component cost amount.

7. The method of claim 4, where the workplace component cost amounts comprise at least one workplace component cost amount categorizable as a facility interior design features component cost amount.

8. The method of claim 4, where the workplace component cost amounts comprise at least one workplace component cost amount categorizable as a training and assessment component cost amount.

9. The method of claim 1, where the workplace design feature investment amounts comprise:
a fit of workspace features to work needs investment amount;
a comfort investment amount;
a support for communication investment amount;
a support for collaboration investment amount;
a job and environmental control investment amount;
a support for sense of community investment amount; or,
combinations thereof.

10. The method of claim 9, where:
the fit of workspace features to work needs investment amount is associated with:
an optimize seating cost amount;
an optimize workstation task light cost amount;
an optimize work surface area and shape cost amount;
an optimize side table cost amount;
an optimize keyboard and mouse tray cost amount;
an optimize storage cost amount; or,
an optimize monitor cost amount;
the comfort investment amount is associated with:
the optimize seating cost amount;
the optimize workstation task light cost amount;
the optimize keyboard and mouse tray cost amount; or,
an optimize docking station cost amount;
the support for communication investment amount is associated with:
an optimize enclosure of workstation cost amount;
an optimize signage for way-finding cost amount;
an optimize meeting rooms cost amount; or,
an enhance color, brightness, and texture of walls, floors, and doorways cost amount;
the support for collaboration investment amount is associated with:
an optimize technology in meeting space cost amount; or,
the optimize meeting rooms cost amount;
the job and environmental control investment amount is associated with:
the optimize seating cost amount;
the optimize workstation task light cost amount;
the optimize keyboard and mouse tray cost amount;
the optimize storage cost amount;
the optimize enclosure of workstation cost amount;
the optimize monitor cost amount;
the optimize docking station cost amount;
a provide workstation ergonomic assessment cost amount; or,
a provide ergonomic training cost amount;
the support for sense of community investment amount is associated with:
an optimize signage for way-finding cost amount; or,
an implement custom corporate graphics program cost amount; or,
combinations thereof.

11. The method of claim 1, further comprising:
creating a first customer model identifier for a customer;
associating the business specific data value, the current performance estimate value, the workplace design feature investment amounts, and the calculated predicted business outcome value with the first customer model identifier; and,
storing the business specific data value, the current performance estimate value, the workplace design feature investment amounts, and the calculated predicted business outcome value for later retrieval using the associated first customer model identifier.

12. The method of claim 11, further comprising:
creating a second customer model identifier for the customer;
retrieving the business specific data value, the current performance estimate value, the workplace design feature investment amounts, and the calculated predicted business outcome value using the associated first customer model identifier;
adjusting at least one workplace design feature investment amount of the workplace design feature investment amounts;
re-calculating the predicted business outcome value using the adjusted workplace design feature investment amount and the workplace design feature investment amounts;
associating the business specific data value, the current performance estimate value, the adjusted workplace design feature investment amount, the workplace design feature investment amounts, and the calculated predicted business outcome value with the second customer model identifier; and,
storing the business specific data value, the current performance estimate value, the adjusted workplace design feature investment amount, the workplace design feature investment amounts, and the calculated predicted business outcome value for later retrieval using the associated second customer model identifier.

13. A system for predicting a predicted business outcome value using workplace design feature investment amounts comprising:
an input device operative to receive input from a user;
a storage device operative to store executable instruction sets, the executable instructions sets operable to implement:
a workplace environment type selection module operative to receive a selected workplace environment type;
a business data module operative to receive a business specific data value corresponding to the workplace environment type and a current performance estimate value corresponding to the selected workplace environment type;
a project type selection module operative to receive a selected project type, where the project type corresponds to the selected workplace environment type;
a workplace component cost amount module operative to calculate a plurality of workplace design feature investment amounts for a plurality of workplace design features, where each of the workplace design feature investment amounts correspond to a workplace design feature; and,
a predicted business outcome module 214 operative to calculate a predicted business outcome value using the received workplace design feature investment amounts and the selected project type;
a processor in communication with the input device and the storage device, where the processor is operative to execute the executable instruction sets and process input received from the input device; and,
an output device in communication with the processor and operative to output the calculated predicted business outcome value.

14. The system of claim 13, where:
the workplace component cost amount module is further operative to calculate an adjusted workplace design feature investment amount using the workplace design feature investment amount; and,
the predicted business outcome module 214 is further operative to re-calculate the previously calculated predicted business outcome value using the adjusted workplace design feature investment amount.

15. The system of claim 13, where the workplace component cost amount module is operative to calculate at least one workplace design feature investment amount using at least one workplace component cost amount.

16. The system of claim 15, where the at least one workplace component cost amount is a plurality of workplace component cost amounts.

17. The system of claim 16, where the workplace component cost amounts comprise at least one workplace component cost amount categorizable as a furnishing workplace component cost amount.

18. The system of claim 16, where the workplace component cost amounts comprise at least one workplace component cost amount categorizable as a technology component cost amount.

19. The system of claim 16, where the workplace component cost amounts comprise at least one workplace component cost amount categorizable as a facility interior design features component cost amount.

20. The system of claim 16, where the workplace component cost amounts comprise at least one workplace component cost amount categorizable as a training and assessment component cost amount.

21. The system of claim 1, where the workplace design feature investment amounts comprise:
a fit of workspace features to work needs investment amount;
a comfort investment amount;
a support for communication investment amount;
a support for collaboration investment amount;
a job and environmental control investment amount;
a support for sense of community investment amount; or,
combinations thereof.

22. The system of claim 21, where:
the fit of workspace features to work needs investment amount is associated with:
an optimize seating cost amount;
an optimize workstation task light cost amount;
an optimize work surface area and shape cost amount;
an optimize side table cost amount;
an optimize keyboard and mouse tray cost amount;
an optimize storage cost amount; or,
an optimize monitor cost amount;
the comfort investment amount is associated with:
the optimize seating cost amount;
the optimize workstation task light cost amount;
the optimize keyboard and mouse tray cost amount; or,
an optimize docking station cost amount;
the support for communication investment amount is associated with:
an optimize enclosure of workstation cost amount;
an optimize signage for way-finding cost amount;
an optimize meeting rooms cost amount; or,
an enhance color, brightness, and texture of walls, floors, and doorways cost amount;
the support for collaboration investment amount is associated with:
an optimize technology in meeting space cost amount; or,
the optimize meeting rooms cost amount;
the job and environmental control investment amount is associated with:
the optimize seating cost amount;
the optimize workstation task light cost amount;
the optimize keyboard and mouse tray cost amount;
the optimize storage cost amount;
the optimize enclosure of workstation cost amount;
the optimize monitor cost amount;
the optimize docking station cost amount;
a provide workstation ergonomic assessment cost amount; or,
a provide ergonomic training cost amount;
the support for sense of community investment amount is associated with:
an optimize signage for way-finding cost amount; or,
an implement custom corporate graphics program cost amount; or,
combinations thereof.

23. The system of claim 13, where:
the workplace environment type selection module is operative to create a first customer model identifier for a customer;
the predicted business outcome module 214 is operative to associate the business specific data value, the current performance estimate value, the workplace design feature investment amounts, and the calculated predicted business outcome value with the first customer model identifier; and,
the storage device is configured to store the business specific data value, the current performance estimate value, the workplace design feature investment amounts, and the calculated predicted business outcome value for later retrieval using the associated first customer model identifier.

24. The system of claim 23, where:
the workplace environment type selection module is further operative to:
create a second customer model identifier for the customer; and,
retrieve the business specific data value, the current performance estimate value, the workplace design feature investment amounts, and the calculated predicted business outcome value using the associated first customer model identifier from the storage device;
the workplace component cost module is further operative to calculate an adjusted workplace design feature investment amount using at least one of the workplace design feature investment amounts;
the predicted business outcome module 214 is further operative to re-calculate the predicted business outcome value using the calculated adjusted workplace design feature investment amount; and
the storage device is configured to store the business specific data value, the current performance estimate value, the calculated adjusted workplace design feature investment amount, the workplace design feature investment amounts, and the calculated predicted business outcome value for later retrieval using the second customer model identifier.

25. A system for predicting a predicted business outcome value using workplace design feature investment amounts comprising:
means for receiving a selection of a workplace environment type;
means for receiving a business specific data value corresponding to the workplace environment type;
means for receiving a current performance estimate values corresponding to the workplace environment type;
means for receiving a selection of a project type, where the project type corresponds to the selected workplace environment type;
means for calculating a plurality of workplace design feature investment amounts for a plurality of workplace design features, where each of the workplace design feature investment amounts correspond to a workplace design feature;
means for calculating a predicted business outcome value using the received workplace design feature investment amounts and the selected project type; and,
means for outputting the calculated predicted business outcome value.
